(19) United States
(12) Patent Application Publication
(10) Pub. No.: US 2017/0187755 A1
(43) Pub. Date: Jun. 29, 2017

(54) CORRELATION OF INTERCEPT RELATED INFORMATION

(71) Applicant: NOKIA SOLUTIONS AND NETWORKS OY, Espoo (FI)

(72) Inventor: Nagaraja RAO, Boca Raton, FL (US)

(73) Assignee: NOKIA SOLUTIONS AND NETWORKS OY, Espoo (FI)

(21) Appl. No.: 15/325,288

(22) PCT Filed: Jul. 11, 2014
(86) PCT No.: PCT/EP2014/064986

§ 371 Date: Jan. 10, 2017

(51) Int. Cl. H04L 29/06

(52) U.S. Cl. CPC H04L 63/306; H04L 63/0281; H04L 65/1006

(57) ABSTRACT

It is provided a method, comprising checking if a value of a main correlation identifier comprised in a first correlation message received from a first node and a value of the main correlation identifier comprised in a second correlation message received from a second node different from the first node are the same, wherein the first correlation message additionally comprises a first secondary correlation identifier, and the second correlation message additionally comprises a second secondary correlation identifier; and the method further comprises generating, if the value of the main correlation identifier comprised in the first correlation message and the value of the main correlation identifier comprised in the second correlation message are the same, a main correlation message comprising the first secondary correlation identifier.

### FIELD OF THE INVENTION

The present invention relates to an apparatus, a method, and a computer program product related to lawful interception. More particularly, the present invention relates to an apparatus, a method, and a computer program product related to intercepting communication.

### BACKGROUND OF THE INVENTION

### Abbreviations

3GPP 3rd Generation Partnership Project

aka also known as

ADMF Administration Function

AGW Access Gateway

AF Access Function

AN Access Node

AS Application Server

ATIS Alliance for Telecommunications Industry Solutions

BCF Border Control Function

CALEA Communications Assistance for Law Enforcement Act

CC Call Content (or Communication Content)

CII Call Identifying Information (aka IRI)

CS Circuit Switched

CSCF Call State Control Function

CSP Communication Service Provider

CTF CC Intercept Triggering Function

DF Delivery Function

DF2 Delivery Function 2 (for IRI)

DF3 Delivery Function 3 (for CC)

EDGE Enhanced Datarate for GSM Evolution

EPS Evolved Packet System

ETSI European Telecommunications Standards Institute

ETSI TC LI ETSI Technical Committee Lawful Interception

GGSN Gateway GPRS Support Node

GPRS Generic Packet Radio Service

GSN GPRS Support Nodes

HI1 Handover Interface 1 (for admin)

HI2 Handover Interface 2 (for IRI)

HI3 Handover Interface 3 (for CC)

IBCF Interworking BCF

I-CSCF Interrogating CSCF

IAP Internet Access Point

ICE Intercepting Control Element

ID Identity or Identifier

Id Identity or Identifier

IM-MGW IMS Media Gateway

IMS IP Multimedia System

IMS-AGW IMS Access Gateway

IP Internet Protocol

IRI Intercept Related Information

LEA Law Enforcement Agency

LEMF Law Enforcement Monitoring Facility

LI Lawful Interception

LIG LI Gateway

LIID Lawful Interception Identifier

LIMS Lawful Interception Management System

LTE Long Term Evolution

LTE-A LTE Advanced

MF Mediation Function

MGCF Media Gateway Control Function

MGW Media Gateway

MRFC Media Resource Function Controller

MRFP Media Resource Function Processor

NSN Nokia Solutions and Networks

P-CSCF Proxy CSCF

PCRF Policy and Charging Rules Function

PDN Packet Data Network

PDN-GW PDN-Gateway

PDP Packet Data Protocol

S-CSCF Serving CSCF

TrGW Transit Gateway

TS Technical Specification

SA3 Services and Systems Aspects TSG 3

SDP Session Description Protocol

SIP Session Initiation Protocol

UMTS Universal Mobile Telecommunications System

US United States

UTRAN Universal Terrestrial Radio Access Network

VoIP Voice over IP

WiFi Wireless Fidelity

X1 X1 Interface (for admin between ADMF and access function)

X2 X2 Interface (for IRI between access function and DF2)

X3 X3 Interface (for CC between access function and DF3)

Lawful Interception (LI) is a legally authorized process of intercepting the communication of private individuals. The interception process is strongly regulated by national laws and telecom acts in each country/region.

3GPP TS 33.107 and TS 33.108 define LI configuration, internal and external LI interface for 3GPP network architectures, and 3GPP defined services. ATIS Standards in North America define the external LI interface to networks deployed in North America. This present application is related to IMS sessions, and therefore, the focus is on LI architecture related to IMS sessions.

Some of the LI architectures defined in 3GPP TS 33.107 are depicted in FIG. 1.

The various LI architecture diagrams shown in FIG. 1 give a background on LI architectures that relate to various network configurations, and also highlight the complexity related to the lawful interception of IMS sessions as so many network nodes are involved. The diagrams A to E are taken from 3GPP TS 33.107 and diagrams F and G are self generated. The diagram E is based on the recent approved NSN CR SA31114_34r2 to 3GPP SA3 LI on VoIP interception architecture definition, which has been accepted into 3GPP TS 33.107.

The diagram A of FIG. 1 shows the architecture for the packet data interception and delivery of Intercept Related Information (IRI) and Communication Content (CC) in reference to a GPRS/UMTS packet core. The diagram B shows the architecture for the packet data interception and delivery of IRI and CC in reference to an EPS packet core. The diagram C shows the architecture for interception and delivery of IRI for IMS sessions. The diagram D shows the architecture for the interception and delivery of IRI and CC for IMS conferencing sessions. The diagram E shows the architecture at an abstract level for the interception and delivery of VoIP CC. The diagram F shows the architecture for the interception and delivery of CC when the target's CC is intercepted at the PDN-GW or GGSN. The diagram G shows the architecture for the interception and delivery of CC when the target's CC is intercepted at the IMS-AGW. In reference to both diagrams F and G, the TrGW and IM-MGW provide the CC interception when an incoming call to the target gets forwarded to another CSP's network. The TrGW also provides the CC interception when the intended subscriber is roaming (IMS roaming). In reference to diagrams F and G, the P-CSCF, IBCF and MGCF provide the CC Intercept Trigger to activate the CC interception at the node that performs the actual CC interception.

Intercept Related Information (also named Call Data or CD in the US) comprises information about the targeted communications, including destination of a voice call (e.g., called party's telephone number), source of a call (caller's phone number), time of the call, duration, etc, which may also be named meta-data. Communication Content is namely the stream of data carrying the call.

The focus here is just on the IMS-related LI architectures. Not all the network nodes shown in FIG. 1 (diagrams F and G) perform the interception for a given IMS session at a given time. In other words, in most situations, only one of the network nodes will provide the CC interception. However, in some situations, more than one network node may be involved.

One example is the case where an incoming call to the target gets forwarded. Before the forwarding (e.g., call forward do not answer case), the PDN-GW/GGSN or the IMS-AGW associated with the target may provide the CC interception. After the call forwarding occurs, PDN-GW or GGSN associated with the forwarded-to user or the TrGW or the IM-MGW may provide the CC interception. Another example is the case where the target subscriber initiates an ad-hoc conference call. In this case, both the S-CSCF and the AS/MRFC may provide the IRI interception. The CC interception may happen at one of the nodes shown in diagram F and G or at the MRFP as show in diagram D.

It is an LI requirement that all the delivered IRI reports and the CC packets shall be correlated to each other. In other words, one IRI message shall be correlated to another IRI message that relates to the same session. The CC packets that correspond to that IMS session have to be correlated to each other and also have to be correlated to the corresponding IMS IRI messages related to the same session. With the possibility of involvement of different network nodes for the IRI interception and the CC interception, the correlating the information delivered to the LEA can be a challenge. One way is to have some mechanism within the network infrastructure so that one Correlation ID is used for all intercepted communication traffic—whether it is IRI or the CC. For example, the NSN implementation of IMS-based VoIP LI follows this approach. In this approach, the network nodes have to implement a method of exchanging that single correlation ID. The other option is to have a mechanism to inform the LEA how different communication traffics have to be correlated. The current published standards follow this approach.

Until the recently approved NSN CRs, the 3GPP LI specifications had defined the LI capabilities just for IMS IRI. The architecture expected the CC interception was based on the separate intercept activations at the packet core network. The NSN CRs provided the stage 2 level architecture definitions for the IMS-based VoIP LI capabilities. The NSN CRs also provided the stage 3 text for the delivery of CC. As explained hereinabove, the existing data structure module defined in 3GPP TS 33.108 expects the packets delivered from a bearer (PDP context) to contain the GPRS/EPS Correlation Number. That helps the LEA to correlate different packets coming from one bearer (PDP context). The current data structure module defined in 3GPP TS 33.108 expects the IMS IRI to contain the IMS Correlation Number and the GPRS/EPS Correlation Number of all the bearers (PDP contexts). The ASN.1 of the data structure module defined in 3GPP TS 33.108 is shown in FIG. 8.

In the above definition, the CorrelationValues (noted as Correlation Values in the remaining part of the disclosure) within the IMS IRI is a choice between the three values:
iri-to-cc
iri-to-iri
both-IRI-CC.

The use-cases of the above three choices are not explained very well in the 3GPP TS 33.108. Anyway, for an interception that involves only the IRI, the choice iri-to-iri is used and an interception that involves both IRI and CC, the choice both-IRI-CC is used. The need to have the choice iri-to-cc is questionable. May be it is there to support implementations that provide SIP session interception solely based on the packet data network. This application will not go further into this iri-to-cc case.

The choice both-IRI-CC consists of:
iri-cc
iri-iri

In this, iri-iri is expected to carry the IMS Correlation Number and iri-cc is expected to carry the GPRS/EPS Correlation Numbers associated to the corresponding bearers or PDP contexts.

In NSN's implementation of IMS-based VoIP LI (also now standardized based on NSN CRs), the P-CSCF sends the CC intercept trigger to the PDN-GW or GGSN via the PCRF, if PDN-GW or GGSN is supposed to do the CC interception for a particular call scenario (see diagram F in FIG. 1). The P-CSCF sends the CC intercept trigger to the IMS-AGW (see diagram G in FIG. 1), if IMS-AGW is supposed to the CC interception for a particular call scenario (e.g., non 3GPP access). The IBCF sends the CC interception trigger to the TrGW (see diagrams F and G in FIG. 1), if TrGW is supposed to do the CC interception for a particular call scenario (e.g., forwarded call to another IMS network or intended subscriber is in another IMS network due to IMS roaming scenario). The MGCF sends the CC interception trigger to the IM-MGW (see diagrams F and G in FIG. 1), if IM-MGW is supposed to do the CC interception for a particular call scenario (e.g., forwarded call to PSTN). The P-CSCF, IBCF and MGCF are collectively called CC Intercept Triggering Function in 3GPP TS 33.107 based on the recent updates due to NSN CRs (see diagram E in FIG. 1). The PDN-GW, GGSN, IMS-AGW, TrGW and IM-MGW are collectively called CC

Intercept Function in 3GPP TS 33.107 based on the recent updates due to NSN CRs (see diagram E in FIG. 1).

The CC intercept trigger sent to the CC Intercept Function is supposed to carry a Correlation Identifier, which the CC Intercept Function is supposed to use on the delivery of intercepted packets to the DF3. In the NSN implementation, the Correlation Identifier value, supplied to the CC Intercept Function, is transported with some proprietary SIP headers and thus, the S-CSCF is aware of the Correlation Identifier value contained in the delivered CC. The S-CSCF can deliver this Correlation Identifier to the DF2 which in turn can deliver the same to the LEA.

A new data structure module to carry the VoIP CC on HI3 interface has already been defined (this is CR SA31114_045r2 of NSN, approved at the April-May 2014 meeting). For reference, the ASN.1 object module is shown in FIG. 10.

It is pointed to the parameter with the name VoIPCorrelationNumber (will be noted as VoIP Correlation Number, in the rest of this disclosure). It is similar to an EPS Correlation Number, however, for the CC Intercept Function, this will be provided by the CC Intercept Triggering Function (see diagram E in FIG. 1). Now the IMS IRI messages have to contain this VoIP Correlation Number instead of the GPRS/EPS Correlation Number. FIG. 11 shows an extension of the structure of FIG. 9 to illustrate the use of the 3GPP TS 33.108 data structure module for the Correlation Values delivered in the IMS IRI messages when the same VoIP Correlation Number is also used as IMS Correlation Number.

FIG. 11 illustrates the concepts of NSN implementation of VoIP. In FIG. 11, there are two media bearers associated with an IMS session. The same

Correlation Id (shown as c1) is used as IMS Correlation Number and as VoIP Correlation Number. Whether c1 has to be specified twice for the two media bearers or once is an implementation choice. It may be an issue for the LEAs to isolate the media packets to a particular bearer when the same Correlation Id is used for multiple bearers. But, this design approach has an advantage over the previous concept (shown in FIG. 9) in the sense in this approach the media bearers associated with different IMS sessions can have different Correlation Ids.

### SUMMARY OF THE INVENTION

It is an object of the present invention to improve the prior art.

According to a first aspect of the invention, there is provided an apparatus, comprising exchanging means adapted to exchange a first message of a session initiation protocol related to a call with a first control device, wherein the first message comprises a call identifier of the call; report generating means adapted to generate a report on an interception related information comprising a correlation identifier of the apparatus and the call identifier, wherein the interception related information is based on a second message of the session initiation protocol related to the call.

The apparatus may further comprise triggering means adapted to trigger interception of the call in a media node by a trigger message, wherein the trigger message comprises a media correlation identifier; correlation generating means adapted to generate a correlation message comprising the correlation identifier, the media correlation identifier, and the call identifier.

The apparatus may further comprise inhibiting means adapted to inhibit the report forwarding means from forwarding the report if the correlation forwarding means forwards the correlation message.

The apparatus may further comprise report forwarding means adapted to forward the report to a delivery function device; and correlation forwarding means adapted to forward the correlation message to the delivery function device.

The correlation forwarding means and the report forwarding means may be adapted to forward the correlation message separately from the report.

The exchanging means may be adapted to exchange a third message of the session initiation protocol related to the call with a second control device, wherein the third message comprises the call identifier; and the apparatus may comprise interception message generating means may be adapted to generate an interception message comprising the third message and at least one of the correlation identifier and the call identifier.

The exchanging means may comprise at least one of the following functions:
serving call state control function;
proxy call state control function;
application server; and
media resource function controller.

According to a second aspect of the invention, there is provided an apparatus, comprising exchanging circuitry configured to exchange a first message of a session initiation protocol related to a call with a first control device, wherein the first message comprises a call identifier of the call; report generating circuitry configured to generate a report on an interception related information comprising a correlation identifier of the apparatus and the call identifier, wherein the interception related information is based on a second message of the session initiation protocol related to the call.

The apparatus may further comprise triggering circuitry configured to trigger interception of the call in a media node by a trigger message, wherein the trigger message comprises a media correlation identifier; correlation generating circuitry configured to generate a correlation message comprising the correlation identifier, the media correlation identifier, and the call identifier.

The apparatus may further comprise inhibiting circuitry configured to inhibit the report forwarding circuitry from forwarding the report if the correlation forwarding circuitry forwards the correlation message.

The apparatus may further comprise report forwarding circuitry configured to forward the report to a delivery function device; and correlation forwarding circuitry configured to forward the correlation message to the delivery function device.

The correlation forwarding circuitry and the report forwarding circuitry may be configured to forward the correlation message separately from the report.

The exchanging circuitry may be configured to exchange a third message of the session initiation protocol related to the call with a second control device, wherein the third message comprises the call identifier; and the apparatus may comprise interception message generating circuitry may be configured to generate an interception message comprising the third message and at least one of the correlation identifier and the call identifier.

The exchanging circuitry may comprise at least one of the following functions:
serving call state control function;
proxy call state control function;
application server; and
media resource function controller.

According to a third aspect of the invention, there is provided an apparatus, comprising first match checking means adapted to check if a value of a main correlation identifier comprised in a first correlation message received from a first node and a value of the main correlation identifier comprised in a second correlation message received from a second node different from the first node are the same, wherein the first correlation message additionally comprises a first secondary correlation identifier, and the second correlation message additionally comprises a second secondary correlation identifier; and the apparatus further comprises generating means adapted to generate, if the value of the main correlation identifier comprised in the first correlation message and the value of the main correlation identifier comprised in the second correlation message are the same, a main correlation message comprising the first secondary correlation identifier.

The generating means may be adapted to generate the main correlation message such that it comprises additionally the second secondary correlation identifier.

One of the first correlation message and the second correlation message may additionally comprise an interception related information, and the generating means may be adapted to include the interception related message into the main correlation message.

The apparatus may further comprise first analyzing means adapted to analyze if a received first interception message comprising a first interception related information comprises one of the first secondary correlation identifier, the second secondary correlation identifier, and the main correlation identifier; first forwarding means adapted to forward the first interception related information together with the first secondary correlation identifier and the second secondary correlation identifier if the received first interception message comprises one of the first secondary correlation identifier and the second secondary correlation identifier.

The apparatus may further comprise first inhibiting means adapted to inhibit the generating means from including the second secondary correlation identifier in the main correlation message; second analyzing means adapted to analyze if a received second interception message comprising a second interception related information comprises one of the first secondary correlation identifier, the second secondary correlation identifier, and the main correlation identifier; forwarding means adapted to forward the second interception related information together with the first secondary correlation identifier if the received interception message comprises one of the first secondary correlation identifier and the second secondary correlation identifier; second inhibiting means adapted to inhibit the forwarding means from forwarding the second secondary correlation identifier with the second interception related information.

The apparatus may further comprise multiplicity checking means adapted to check if the second correlation message comprises two values of the main correlation identifier; second match checking means adapted to check if a value of the main correlation identifier comprised in a third correlation message received from a third node different from the first node and different from the second node is the same as one of the values of the main correlation identifier comprised in the second correlation message; wherein the third correlation message may additionally comprise a third secondary correlation identifier; and the generating means may be adapted to generate, if the value of the main correlation identifier comprised in the third correlation message is the same as one of the values of the main correlation identifier comprised by the second correlation message, the main correlation message additionally comprising the third secondary correlation identifier.

One of the first and second secondary correlation identifiers may be an identifier of a media transporting call content of the call. One of the first and second secondary correlation identifiers may be an identifier of a message of a session initiation protocol related to the call. The main correlation identifier may be a call identifier of a session initiating protocol session. In some embodiments, the main correlation message does not comprise the main correlation identifier.

According to a fourth aspect of the invention, there is provided an apparatus, comprising first match checking circuitry configured to check if a value of a main correlation identifier comprised in a first correlation message received from a first node and a value of the main correlation identifier comprised in a second correlation message received from a second node different from the first node are the same, wherein the first correlation message additionally comprises a first secondary correlation identifier, and the second correlation message additionally comprises a second secondary correlation identifier; and the apparatus further comprises generating circuitry configured to generate, if the value of the main correlation identifier comprised in the first correlation message and the value of the main correlation identifier comprised in the second correlation message are the same, a main correlation message comprising the first secondary correlation identifier.

The generating circuitry may be configured to generate the main correlation message such that it comprises additionally the second secondary correlation identifier.

One of the first correlation message and the second correlation message may additionally comprise an interception related information, and the generating circuitry may be configured to include the interception related message into the main correlation message.

The apparatus may further comprise first analyzing circuitry configured to analyze if a received first interception message comprising a first interception related information comprises one of the first secondary correlation identifier, the second secondary correlation identifier, and the main correlation identifier; first forwarding circuitry configured to forward the first interception related information together with the first secondary correlation identifier and the second secondary correlation identifier if the received first interception message comprises one of the first secondary correlation identifier and the second secondary correlation identifier.

The apparatus may further comprise first inhibiting circuitry configured to inhibit the generating circuitry from including the second secondary correlation identifier in the main correlation message; second analyzing circuitry configured to analyze if a received second interception message comprising a second interception related information comprises one of the first secondary correlation identifier, the second secondary correlation identifier, and the main correlation identifier; forwarding circuitry configured to forward the second interception related information together with the first secondary correlation identifier if the received interception message comprises one of the first secondary correlation identifier and the second secondary correlation identifier; second inhibiting circuitry configured to inhibit the forwarding circuitry from forwarding the second secondary correlation identifier with the second interception related information.

The apparatus may further comprise multiplicity checking circuitry configured to check if the second correlation message comprises two values of the main correlation identifier; second match checking circuitry configured to check if a value of the main correlation identifier comprised in a third correlation message received from a third node different from the first node and different from the second node is the same as one of the values of the main correlation identifier comprised in the second correlation message; wherein the third correlation message may additionally comprise a third secondary correlation identifier; and the generating circuitry may be configured to generate, if the value of the main correlation identifier comprised in the third correlation message is the same as one of the values of the main correlation identifier comprised by the second correlation message, the main correlation message additionally comprising the third secondary correlation identifier.

One of the first and second secondary correlation identifiers may be an identifier of a media transporting call content of the call. One of the first and second secondary correlation identifiers may be an identifier of a message of a session initiation protocol related to the call. The main correlation identifier may be a call identifier of a session initiating protocol session. In some embodiments, the main correlation message does not comprise the main correlation identifier.

According to a fifth aspect of the invention, there is provided an apparatus, comprising intercepting means adapted to intercept a call content of a call of a session initiation protocol after having received a trigger comprising a media correlation identifier of a media transporting the call; inhibiting means adapted to inhibit the apparatus from providing a correlation message comprising the media correlation identifier to a delivery function, wherein the correlation message does not comprise the call content.

The media means may be adapted to provide at least one of the following functions:
a packet data network gateway;
a gateway generic packet radio service support node;
an internet protocol multimedia subsystem access gateway;
an internet protocol multimedia subsystem media gateway; and
a transit gateway.

According to a sixth aspect of the invention, there is provided an apparatus, comprising intercepting circuitry configured to intercept a call content of a call of a session initiation protocol after having received a trigger comprising a media correlation identifier of a media transporting the call; inhibiting circuitry configured to inhibit the apparatus from providing a correlation message comprising the media correlation identifier to a delivery function, wherein the correlation message does not comprise the call content.

The media circuitry may be configured to provide at least one of the following functions:
a packet data network gateway;
a gateway generic packet radio service support node;
an internet protocol multimedia subsystem access gateway;
an internet protocol multimedia subsystem media gateway; and
a transit gateway.

According to a seventh aspect of the invention, there is provided an apparatus, comprising extracting means adapted to extract a first session correlation identifier and a first media correlation identifier from a received correlation message; first session evaluating means adapted to evaluate if a received first report comprises the first session correlation identifier, wherein a first interception related information is comprised in the first report; first media evaluating means adapted to evaluate if a received first message comprises the first media correlation identifier, wherein a first call content is comprised in the first message; correlating means adapted to correlate the first interception related information and the first call content if the first report comprises the first session correlation identifier and the first message comprises the first media correlation identifier.

The extracting means may be adapted to extract a second session correlation identifier different from the first session correlation identifier from the correlation message; and the apparatus may comprise second session evaluating means adapted to evaluate if a received second report comprises the second session correlation identifier, wherein a second interception related information is comprised in the second report; wherein the correlating means may be adapted to correlate the second interception related information with the first interception related information and the first call content if the second report comprises the second session correlation identifier.

The first report may be received from a first report delivery function, and the second report may be received from a second report delivery function different from the first report delivery function.

The extracting means may be adapted to extract a second media correlation identifier different from the first media correlation identifier from the correlation message; and the apparatus may comprise second media evaluating means adapted to evaluate if a received second message comprises the second media correlation identifier, wherein a second call content may be comprised in the second message; wherein the correlating means may be adapted to correlate the second call content with the first interception related information and the first call content if the second message comprises the second media correlation identifier.

The first message may be received from a first media node, and the second message may be received from a second media node different from the first media node.

According to an eighth aspect of the invention, there is provided an apparatus, comprising extracting circuitry configured to extract a first session correlation identifier and a first media correlation identifier from a received correlation message; first session evaluating circuitry configured to evaluate if a received first report comprises the first session correlation identifier, wherein a first interception related information is comprised in the first report; first media evaluating circuitry configured to evaluate if a received first message comprises the first media correlation identifier, wherein a first call content is comprised in the first message; correlating circuitry configured to correlate the first interception related information and the first call content if the first report comprises the first session correlation identifier and the first message comprises the first media correlation identifier.

The extracting circuitry may be configured to extract a second session correlation identifier different from the first session correlation identifier from the correlation message; and the apparatus may comprise second session evaluating circuitry configured to evaluate if a received second report comprises the second session correlation identifier, wherein a second interception related information is comprised in the second report; wherein the correlating circuitry may be configured to correlate the second interception related information with the first interception related information and the first call content if the second report comprises the second session correlation identifier.

The first report may be received from a first report delivery function, and the second report may be received from a second report delivery function different from the first report delivery function.

The extracting circuitry may be configured to extract a second media correlation identifier different from the first media correlation identifier from the correlation message; and the apparatus may comprise second media evaluating circuitry configured to evaluate if a received second message comprises the second media correlation identifier, wherein a second call content may be comprised in the second message; wherein the correlating circuitry may be configured to correlate the second call content with the first interception related information and the first call content if the second message comprises the second media correlation identifier.

The first message may be received from a first media node, and the second message may be received from a second media node different from the first media node.

According to a ninth aspect of the invention, there is provided a method, comprising exchanging a first message of a session initiation protocol related to a call with a first control device, wherein the first message comprises a call identifier of the call; generating a report on an interception related information comprising a correlation identifier of an apparatus performing the method and the call identifier, wherein the interception related information is based on a second message of the session initiation protocol related to the call.

The method may further comprise triggering interception of the call in a media node by a trigger message, wherein the trigger message comprises a media correlation identifier; generating a correlation message comprising the correlation identifier, the media correlation identifier, and the call identifier.

The method may further comprise inhibiting the report forwarding means from forwarding the report if the correlation forwarding means forwards the correlation message.

The method may further comprise forwarding the report to a delivery function device; and forwarding the correlation message to the delivery function device. The correlation message is forwarded separately from the report.

The method may further comprise exchanging a third message of the session initiation protocol related to the call with a second control device, wherein the third message comprises the call identifier; generating an interception message comprising the third message and at least one of the correlation identifier and the call identifier.

The apparatus may comprise at least one of the following functions:
serving call state control function;
proxy call state control function;
application server; and
media resource function controller.

According to a tenth aspect of the invention, there is provided a method, comprising checking if a value of a main correlation identifier comprised in a first correlation message received from a first node and a value of the main correlation identifier comprised in a second correlation message received from a second node different from the first node are the same, wherein the first correlation message additionally comprises a first secondary correlation identifier, and the second correlation message additionally comprises a second secondary correlation identifier; and the method further comprises generating, if the value of the main correlation identifier comprised in the first correlation message and the value of the main correlation identifier comprised in the second correlation message are the same, a main correlation message comprising the first secondary correlation identifier.

The main correlation message may be generated such that it comprises additionally the second secondary correlation identifier.

One of the first correlation message and the second correlation message may additionally comprise an interception related information, and the interception related message may be included into the main correlation message.

The method may further comprise analyzing if a received first interception message comprising a first interception related information comprises one of the first secondary correlation identifier, the second secondary correlation identifier, and the main correlation identifier; forwarding the first interception related information together with the first secondary correlation identifier and the second secondary correlation identifier if the received first interception message comprises one of the first secondary correlation identifier and the second secondary correlation identifier.

The method may further comprise inhibiting an apparatus performing the method from including the second secondary correlation identifier in the main correlation message; analyzing if a received second interception message comprising a second interception related information comprises one of the first secondary correlation identifier, the second secondary correlation identifier, and the main correlation identifier; forwarding the second interception related information together with the first secondary correlation identifier if the received interception message comprises one of the first secondary correlation identifier and the second secondary correlation identifier; inhibiting the apparatus from forwarding the second secondary correlation identifier with the second interception related information.

The method may further comprise checking if the second correlation message comprises two values of the main correlation identifier; checking if a value of the main correlation identifier comprised in a third correlation message received from a third node different from the first node and different from the second node is the same as one of the values of the main correlation identifier comprised in the second correlation message; wherein the third correlation message additionally may comprise a third secondary correlation identifier; and generating, if the value of the main correlation identifier comprised in the third correlation message is the same as one of the values of the main correlation identifier comprised by the second correlation message, the main correlation message additionally comprising the third secondary correlation identifier.

One of the first and second secondary correlation identifiers may be an identifier of a media transporting call content of the call. One of the first and second secondary correlation identifiers is an identifier of a message of a session initiation protocol related to the call. The main correlation identifier may be a call identifier of a session initiating protocol session. In some embodiments, the main correlation message does not comprise the main correlation identifier.

According to an eleventh aspect of the invention, there is provided a method, comprising intercepting a call content of a call of a session initiation protocol after having received a trigger comprising a media correlation identifier of a media transporting the call; inhibiting an apparatus performing the method from providing a correlation message comprising the media correlation identifier to a delivery function, wherein the correlation message does not comprise the call content.

The apparatus may provide at least one of the following functions:
a packet data network gateway;
a gateway generic packet radio service support node;
an internet protocol multimedia subsystem access gateway;
an internet protocol multimedia subsystem media gateway; and
a transit gateway.

According to a twelfth aspect of the invention, there is provided a method, comprising extracting a first session correlation identifier and a first media correlation identifier from a received correlation message; evaluating if a received first report comprises the first session correlation identifier, wherein a first interception related information is comprised in the first report; evaluating if a received first message comprises the first media correlation identifier, wherein a first call content is comprised in the first message; correlating the first interception related information and the first call content if the first report comprises the first session correlation identifier and the first message comprises the first media correlation identifier.

The method may further comprise extracting a second session correlation identifier different from the first session correlation identifier from the correlation message; evaluating if a received second report comprises the second session correlation identifier, wherein a second interception related information is comprised in the second report; and correlating the second interception related information with the first interception related information and the first call content if the second report comprises the second session correlation identifier.

The first report may be received from a first report delivery function, and the second report may be received from a second report delivery function different from the first report delivery function.

The method may further comprise extracting a second media correlation identifier different from the first media correlation identifier from the correlation message; evaluating if a received second message comprises the second media correlation identifier, wherein a second call content may be comprised in the second message; and correlating the second call content with the first interception related information and the first call content if the second message comprises the second media correlation identifier.

The first message may be received from a first media node, and the second message may be received from a second media node different from the first media node.

Each of the methods of the ninth to twelfth aspects may be a method for intercepting.

According to a thirteenth aspect of the invention, there is provided a computer program product comprising a set of instructions which, when executed on an apparatus, is configured to cause the apparatus to carry out the method according to any one of the ninth to twelfth aspects. The computer program product may be embodied as a computer-readable medium or directly loadable into a computer.

According to some embodiments of the invention, at least one of the following advantages may be achieved:
all IRI reports and CC packets may be correlated to each other;
the design may be flexible;
the data structure is backwards compatible to present 3GPP TS 33.108;
Embodiments of the invention are not dependent on whether or not DF2 used for packet data IRI delivery is same as the DF2 used for the IMS IRI delivery.
The delivery method accommodates the delivery of correlation information before and after the media bearer is established. Through the use of a Correlation Message, the delivery method is able to provide the correlation information to the LEA even if no SIP messages are exchanged between the Target and the IMS once the media bearer is setup.
The delivery method accommodates the possibility of Target being involved in multiple concurrent IMS sessions. That is because the Correlation Number to be used for a particular media bearer is determined and told to the CC Intercept Function by the IMS network nodes and all the correlation information is delivered to the LEA.
The delivery method is not dependent on whether or not a packet data interception is active.
The delivery method is designed to support the possibility of one or more IMS SIP nodes providing the interception of SIP messages.
In addition, the delivery method allows the same variant of the Correlation Values to be used for all type (i.e., IRI only or IRI+CC) of IMS-based VoIP interceptions.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIGS. 1A to 1G show Examples of Lawful Interception Architecture [Source: Partially, 3GPP TS 33.107];

FIG. 2 shows 3GPP TS 33.108 concept used to correlate IMS IRI with CC;

FIG. 3 shows a conventional scenario with two DF2;

FIG. 4 shows a conventional scenario where GPRS/EPS Correlation Number may not be available in time;

FIG. 5 illustrates a conventional problem of multiple IMS Sessions;

FIG. 6 illustrates a conventional problem if no packet data interception order;

FIG. 7 illustrates a scenario with multiple IMS Correlation Numbers;

FIG. 8 illustrates ASN.1 Definition for Correlation Values [Source: 3GPP TS 33.108];

FIG. 9 illustrates usage of conventional data structure module defined in 3GPP TS 33.108;

FIG. 10 illustrates ASN.1 Definition for VoIP CC [Source: 3GPP TS 33.108, NSN CR];

FIG. 11 illustrates use of conventional data structure module defined in 3GPP TS 33.108 for VoIP;

FIG. 12 illustrates an embodiment of the Invention

FIG. 13 illustrates an embodiment with DF2 deriving the Correlation Information;

FIG. 14 illustrates an embodiment of the invention with two media bearers;

FIG. 15 illustrates an embodiment of the invention where media interception point changes;

FIG. 16 illustrates an enhanced data structure module according to embodiments of the invention;

FIG. 17 illustrates usage of the enhanced data structure module according to embodiments of the invention;

FIG. 18 illustrates embodiments of the invention applied to IMS Scenarios;

FIG. 19 illustrates further implementation alternatives according to embodiments of the invention;

FIG. 20 illustrates a call flow according to an embodiment of the invention for an originating call;

FIG. 21 illustrates a call flow according to an embodiment of the invention for a terminating call;

FIG. 22 illustrates a single correlation Id use-case according to an embodiment of the invention;

FIG. 23 illustrates an application of a data structure module for single correlation Id case according to an embodiment of the invention;

FIG. 24 illustrates an application of conventional data structure module for single correlation Id case;

FIG. 25 illustrates an application of conventional data structure module for multiple correlation Id case;

FIG. 26 shows an apparatus according to an embodiment of the invention;

FIG. 27 shows a method according to an embodiment of the invention;

FIG. 28 shows an apparatus according to an embodiment of the invention;

FIG. 29 shows a method according to an embodiment of the invention;

FIG. 30 shows an apparatus according to an embodiment of the invention;

FIG. 31 shows a method according to an embodiment of the invention;

FIG. 32 shows an apparatus according to an embodiment of the invention;

FIG. 33 shows a method according to an embodiment of the invention; and

FIG. 34 shows an apparatus according to an embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

In the figures, c1 is the IMS Correlation Number, and m1 is the EPS Correlation Number associated with the media bearer #1 and m2 is the EPS Correlation Number associated with the media bearer #2. The IMS signalling bearer has the EPS Correlation Number s1.

There are problems in the concepts that relate to the standardized approach, based on the specification, to correlate all IRI reports and CC packages based on informing LEA on the correlation. Embodiments of the invention solve these problems and allow the implementers to have a flexible design approach.

As explained hereinabave, in reference to the IMS sessions, several network nodes may be involved in providing the intercept functions. 3GPP TS 33.108 defines the data structure for delivering more than one correlation numbers in the IRI messages. But, the concepts that govern that data structure are weak and prone to have some errors. For example, the concepts that govern the data structure of 33.108 are based on the assumption that the CC interception for an IMS session is done at the GGSN (as shown in diagram A) and the PDN-GW (as shown in diagram B).

The concepts that define the data structure modules within 3GPP TS 33.108 assume that each GPRS/UMTS PDP context has own GPRS Correlation Number. In the same way, each EPS bearer has own EPS Correlation Number. The packets delivered from the respective nodes (i.e., GGSN or PDN-GW) carry the corresponding GPRS/EPS Correlation Number to the LEA. Using this GPRS/EPS Correlation Number, the LEAs are able to correlate the packets coming off of the one bearer. For an IMS session, these packets coming from the GPRS PDP context or EPS bearer are referred to as CC.

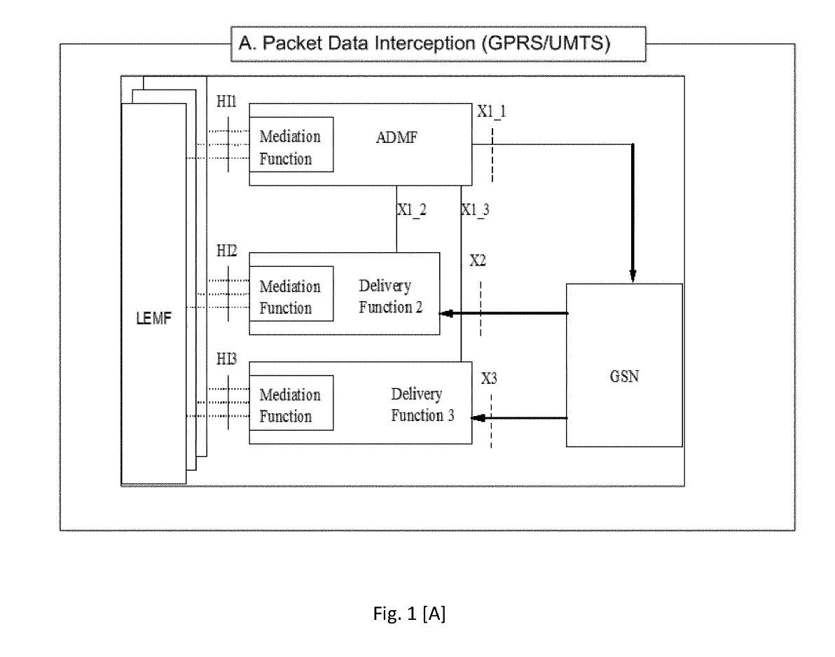

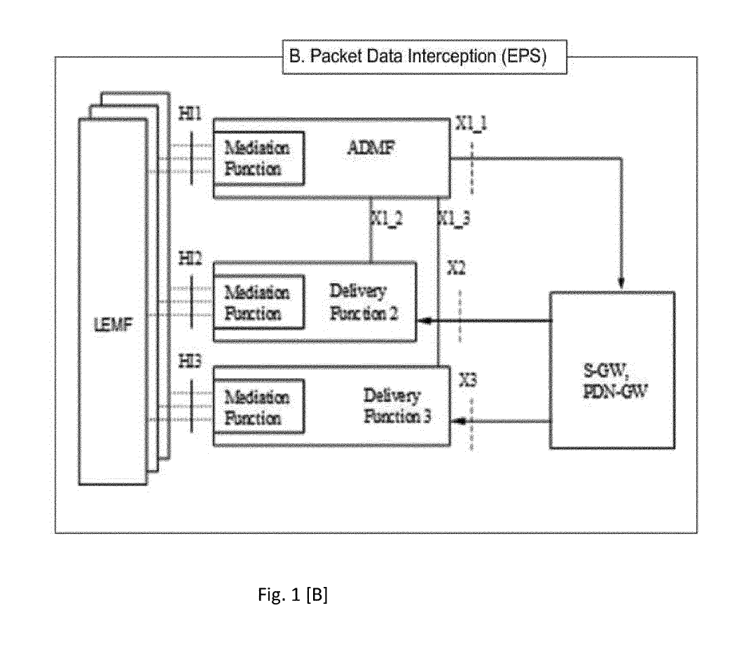

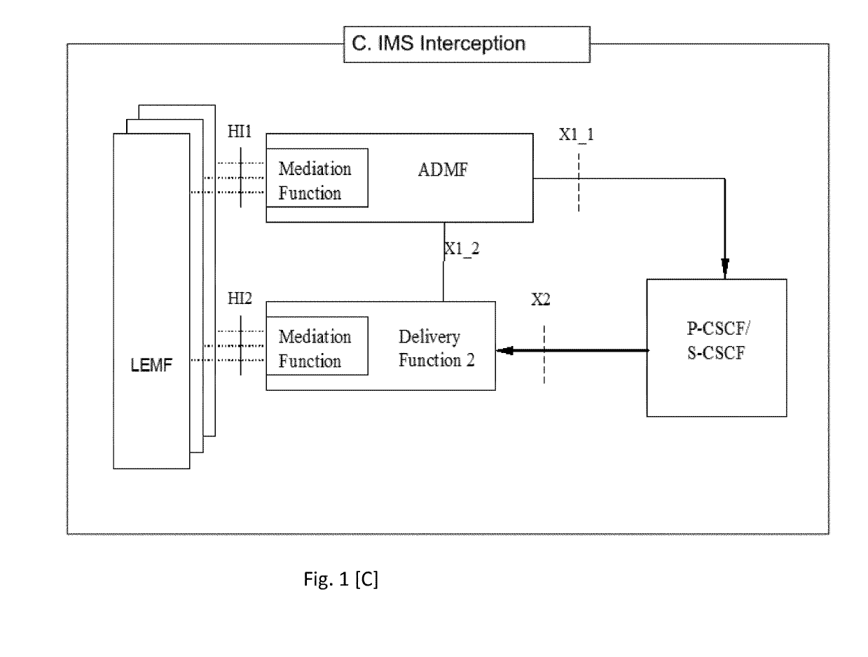

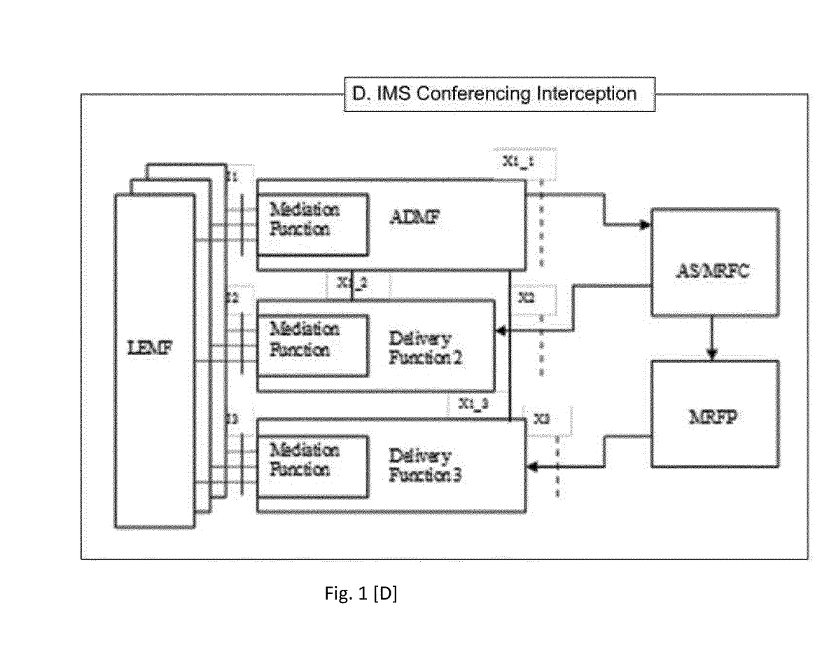

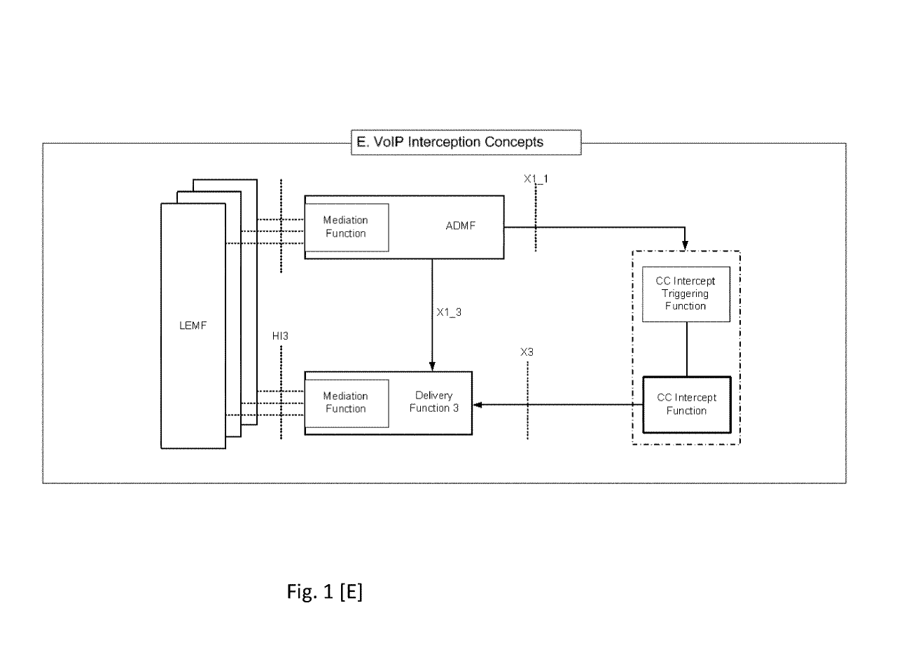

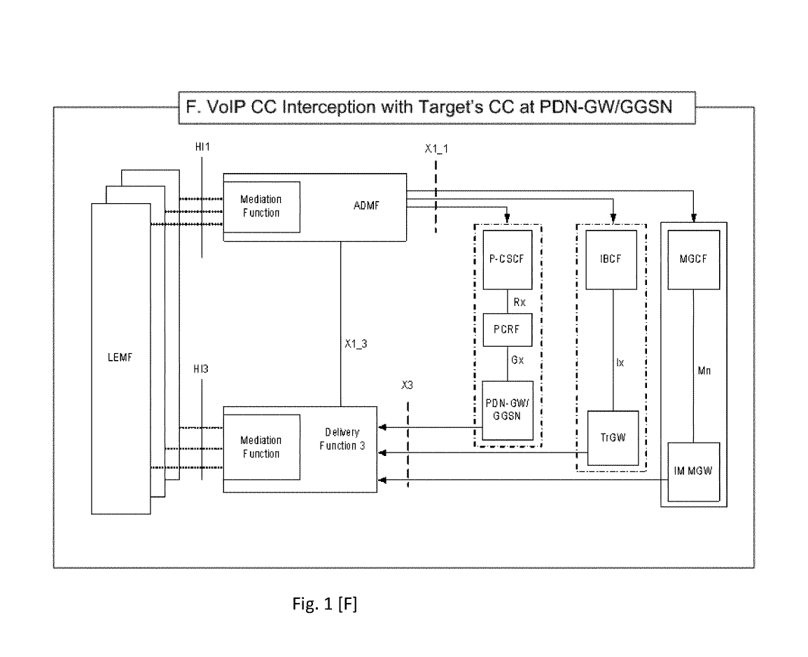

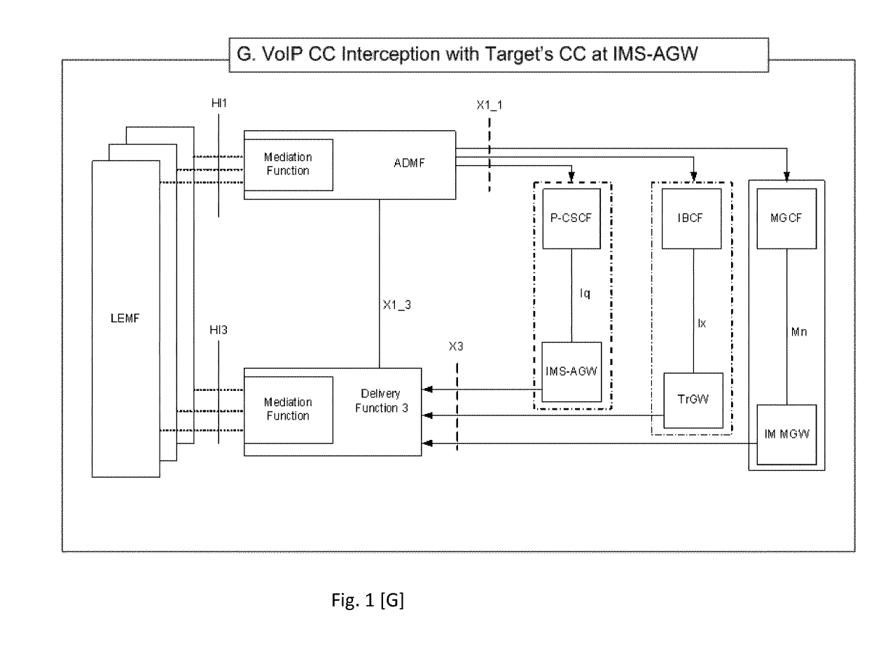

Based on those concepts, a different Correlation Number is used by the IMS node. The data structure module defined in 3GPP TS 33.108 allows the DF2 to deliver this Correlation Number and the GPRS/EPS Correlation Number in the IMS IRI messages. The 3GPP TS 33.108 does not clearly explain how the GPRS/EPS Correlation Number is supplied to the DF2 that delivers the IMS IRI to the LEA. As illustrated in FIG. 1, the DF (DF3) that delivers the CC can be different from the DF (DF2) that delivers the IRI. The DF2 that delivers the packet data IRI can be different from the DF2 that delivers the IMS IRI. So, it is not clear how the DF2 that delivers the IMS IRI can get the GPRS/EPS Correlation Number.

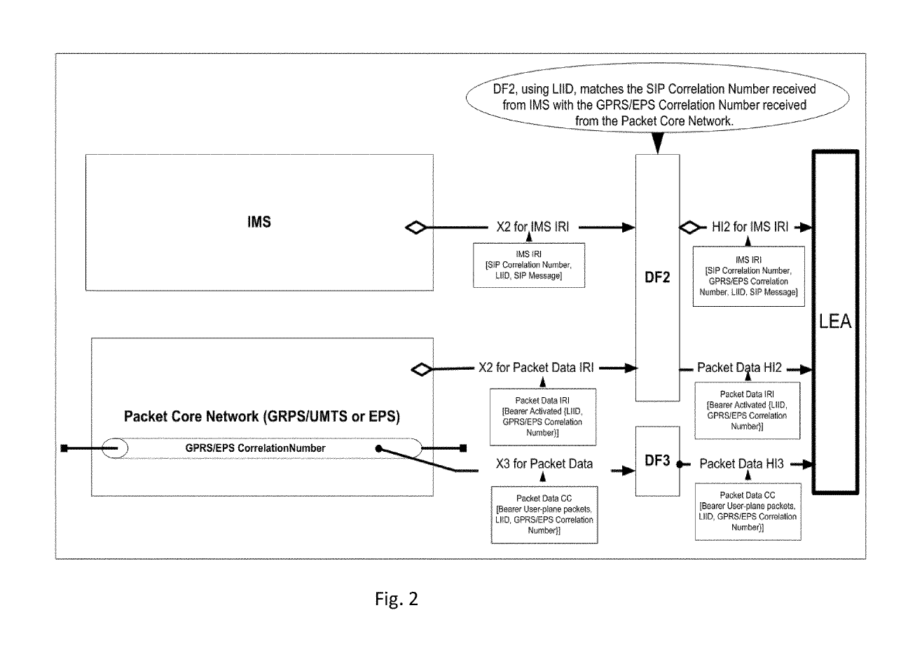

There is one way to make DF2 (that delivers the IMS IRI) have the GPRS/EPS Correlation Number: if the same DF2 is used for the delivery of packet data IRI messages. In this approach, the packet core network (GPRS/UMTS or EPS) as a part of packet data interception, deliver the GPRS/EPS Correlation Number to the DF2 as packet data IRI when the associated PDP context/bearer is created within the packet core network. It is assumed that the packet data IRI and IMS IRI have the same Lawful Interception Identifier (LIID) value. LIID identifies the target to be intercepted. The DF2, with the help of LIID, is able to associate the GPRS/EPS Correlation Number to the IMS Correlation Number and report both Correlation Numbers to the LEA. This particular concept is illustrated in FIG. 2 as an overview.

FIG. 2 illustrates that when a bearer (this is referred to as PDP context in GPRS/UMTS network) within the packet core network is created, the packet core network with an active intercept sends an IRI over the X2 interface (not standardized) to the DF2. This IRI contains the GPRS/EPS Correlation Number, Lawful Intercept Identifier (LIID). When a SIP message is intercepted in the IMS network, the IMS sends the SIP message as an IRI to the same DF2 over the X2 interface (not standardized). This IRI contains the IMS Correlation Number and the LIID. The DF2, while reporting this IMS IRI to the LEA, sends the IMS Correlation Number and the GPRS/EPS Correlation Number to the LEA. The packet core network also delivers the bearer contents as CC to the DF3 over the X3 interface (not standardized). This CC contains the GPRS/EPS Correlation Number and DF3 delivers the CC to the LEA. The LEA is now able to correlate the CC with the IMS IRI since both have the same GPRS/UMTS Correlation Number. These are not explained in this way in the existing standards, but that is presumed to be the concept.

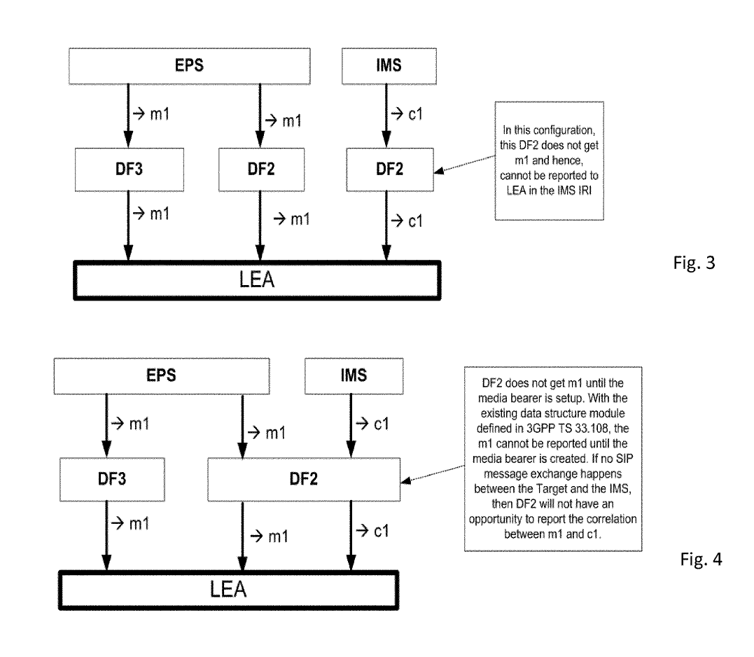

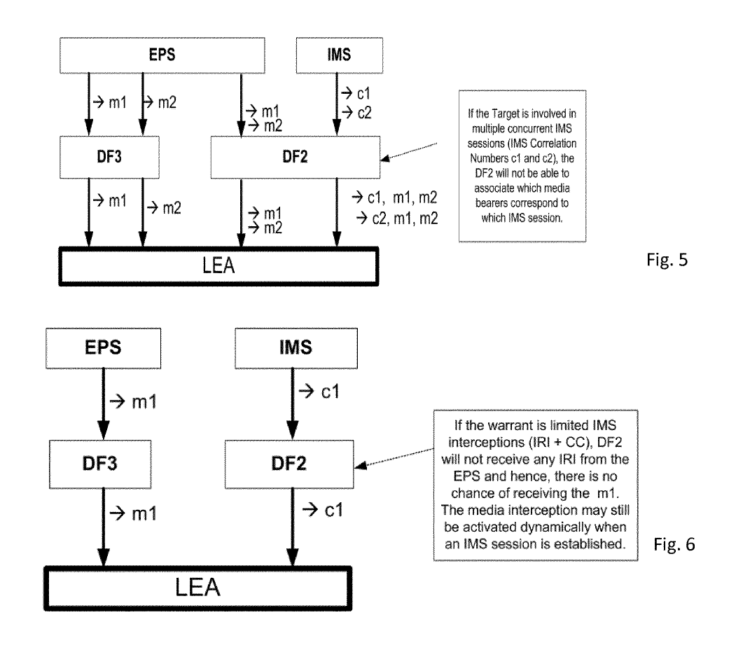

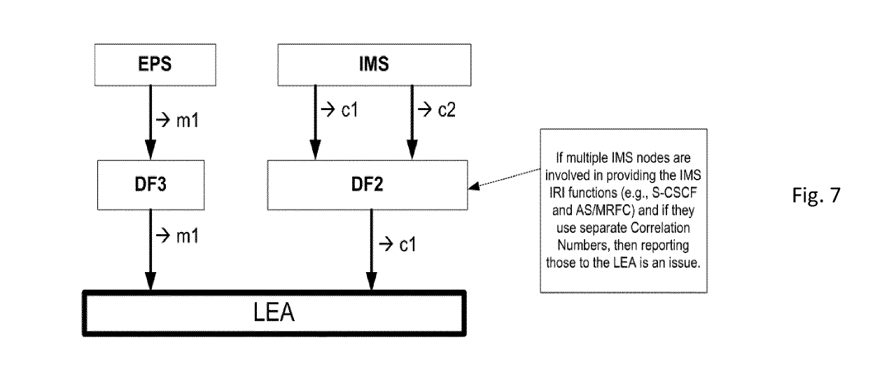

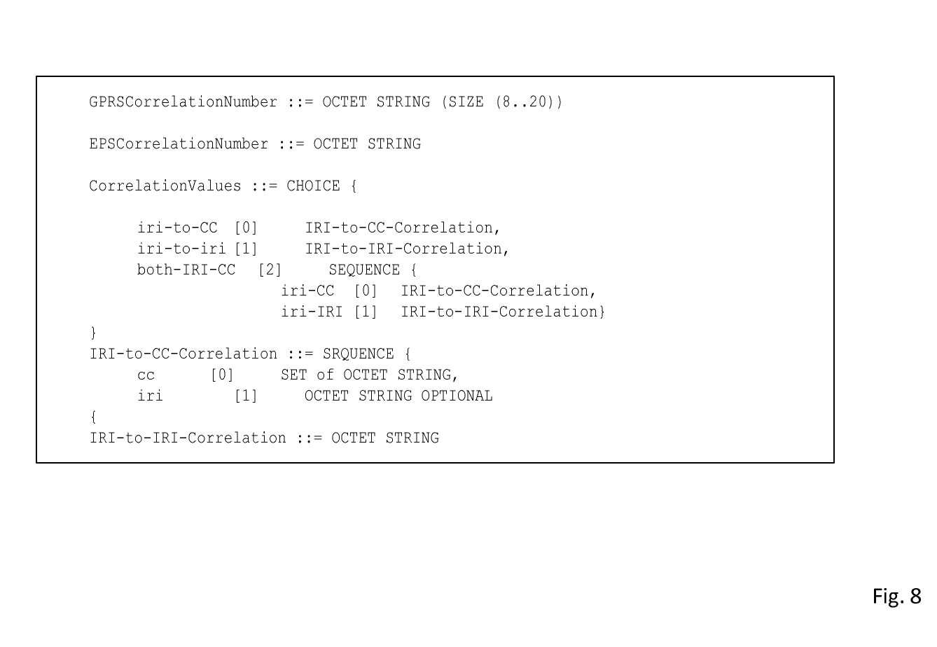

The above concept breaks in the following possible scenarios:
1. If the DF2 used for Packet Data IRI is different from the DF2 used for IMS IRI, then the DF2 used for the IMS IRI is not able to generate the correlation. This is real possible scenario - in NSN implementation, LIG is the DF2 for packet data IRI and LIMS is the DF2 for IMS IRI—two different physical entities (see FIG. 3).
2. This scenario assumes that the case of one DF2 (for packet data IRI and IMS IRI) being used. The media bearer for an IMS session is established as a part of the call setup. So, the Packet Data IRI that carries the GPRS/EPS Correlation Number for that media bearer is reported to the DF2 as and when that bearer is created. The DF2, therefore, cannot report the GPRS/EPS Correlation Number to the LEA in the reported IMS IRI until the media bearer is created. Until a SIP message is exchanged between the target and the IMS network, no IMS IRI is sent to the LEA (see FIG. 4). In other words, once the media bearer is created, the LEA is not able to associate the CC received from the packet core network until a SIP message is received from, or sent to, the target. If no SIP messages are exchanged till the call is released, then that would mean no correlation till the call is released. This is a real weakness of the concept.
3. This scenario also assumes that the case of one DF2 (for packet data IRI and IMS IRI) being used. If the target is involved in another concurrent IMS session with another media bearer, then DF2 may not be able to figure out to which IMS Correlation Number the GPRS/EPS Correlation Numbers have to be correlated. This will thus create a correlation problem (see FIG. 5).
4. This scenario also assumes that the case of one DF2 (for packet data IRI and IMS IRI) being used. It may so happen that an intercept order may just on the IMS session. If this is the case, then there will not be any packet data interception and hence, DF2 is not going to receive any packet data IRI messages (see FIG. 6). With the dynamic activation of CC interception at the packet core network (note: this does not result in packet data IRI), the CC interception may still happen, but there is no correlation.
5. If multiple network nodes are involved in handling a SIP session (e.g., for IMS conference call, the S-CSCF will intercept the IMS IRI for basic part of the call, and AS/MRFC may intercept the IMS IRI for conference-part of the call), and if those network nodes use different IMS Correlation Numbers, then DF2 cannot notify the LEA that the SIP messages intercepted at those nodes are related (see FIG. 7).

In summary, the above paragraphs identify and describe some of the problems with the concepts that are standardized in providing the LI for IMS based sessions.

Recent updates to the 3GPP TS 33.107 and 3GPP TS 33.108 (based on NSN CRs) have enhanced the IMS-based VoIP interception (Diagram E of FIG. 1) with CC interception being done at various nodes (Diagrams F and G of FIG. 1) such as IMS-AGW, PDN-GW/GGSN, TrGW and IM-MGW. In these cases, the LI architectures indicate that the CC Intercept Function (one of the IMS nodes) provides the Correlation Number to the CC Intercept Function (one of the media nodes that intercept the media). As mentioned hereinabove, all these nodes may adopt a method to make use of a coordinated single Correlation Id or in another implementation they all may have separate Correlation Ids. The data structure defined in 33.108 may work if one single Correlation Id is used, but will not work if several Correlation Ids are in use. Furthermore, if several Correlation Ids are in use, no method has been defined that allows the DF2 to associate all those Correlation Ids to one IMS session. In brief, through NSN CRs, a part of the problems may have been corrected at the architecture level. At the detailed level (stage 3), more effort will be required.

As explained hereinabove (problem #2), it appears that 3GPP TS 33.108 fails to realize that iri-cc cannot be reported unless a media bearer (or PDP context) is created within the packet core network. The media bearer (or PDP context) is established as a part of the call establishment and in some rare situations it may not happen till the call is answered (e.g., if the SDP answer is sent in a SIP ACK message). Typically, no SIP messages are exchanged between the user and the IMS network once the call is setup (until the call is released). This implies that there may be situations where the DF2 may never get an opportunity (or get it only at the call release time) to report the GPRS/EPS Correlation Numbers to the LEA. This will be an issue because if that is the case then the LEAs will not be able to correlate the IRIs and the CCs of an IMS session. Additionally, the current data structure module perhaps presumes that GPRS/EPS Correlation Numbers of all bearers (PDP contexts) are reported (note: not all bearers (PDP contexts) carry the CC of an IMS session). With the approach of reporting the GPRS/EPS Correlation Numbers of all bearers (PDP contexts), the method cannot isolate and associate the CC with the appropriate IRI in the event the target is engaged in multiple concurrent calls.

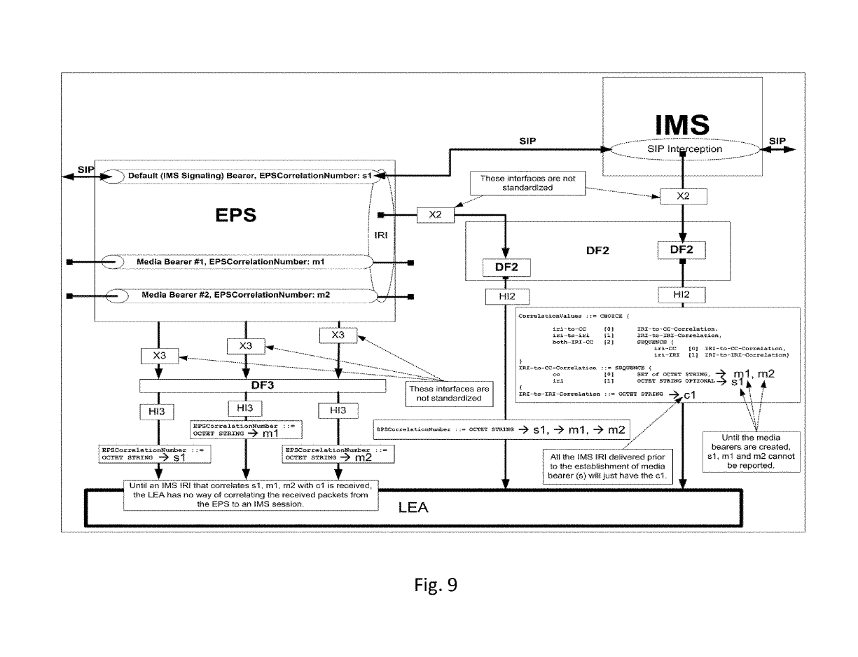

FIG. 9 illustrates the use of the above data structure module in an established call. The example shown in FIG. 9 assumes EPS as the packet core network. In this example, an IMS session has two media bearers. The figure shows the concept on an established call.

All the packets delivered from EPS to the LEA (via DF3) contain the EPS Correlation Number values that correspond to the associated EPS bearer. Note that in the existing LI architecture these packets carry packet-specific CC. All SIP messages and the voice media are treated as CC as far as packet data interception is concerned. The packet core network sends the packet data IRI to the DF2. These IRI also carry the EPS Correlation Number associated with the bearer. If the DF2 used for the packet data IRI and the DF2 used for IMS IRI are one and the same, then that DF2 can use the LIID value received in the packet data IRI and the IMS IRI to associate a correlation between the IMS Correlation Number and the EPS Correlation Number. In this approach, all the hitherto known EPS Correlation Numbers will be associated to the IMS Correlation Numbers. If there are more than one IMS Correlation Numbers for an IMS session, then what DF2 has to do is not explained. Anyway, those are internal functions of a DF2.

Until an IRI message that contains the m1, m2 along with c1 is received, LEA cannot correlate the received media packets with the IRI. Also, if no IRI message is received after the establishment of the media bearers, the LEA will not have an opportunity to receive an IRI that would correlate the m1 and m2 to the c1. This makes the correlation almost impossible. The 3GPP TS 33.108 suggests that the LEA can also associate the CC with the IRI, by comparing the LIID values received in the packets and the IRI. But, if the target is involved in multiple concurrent calls (or multiple call legs), then the LEAs cannot use that logic to associate the CC with the IRI.

Embodiments of the invention provide a method and an apparatus performing the method to deliver the correlation information from different nodes of CSP infrastructure and/or provide a method for the delivery function (DF2) to coordinate and send that information to the LEA and provide instructions on how the LEAs have to use that information. As a part of this method, a new data structure module is defined for the HI2 interface in a more generic way so that different implementations (i.e., other than the NSN implementations) can also take advantage of. The data structure module will support the possibility of multiple call legs, multiple concurrent calls and multiple media streams, as such would solve the problems discussed hereinabove. The idea of multiple concurrent calls, multiple media streams, correlating the SIP messages intercepted at multiple nodes (e.g., S-CSCF, AS, MRFC), are not discussed so far within the industry.

Embodiments of the invention provide a method to deliver the correlation information to the LEAs so as to help the LEAs to correlate the IRI and the CC for an IMS session. The method may be used to support NSN's implementation of VoIP LI (where only one Correlation Identifier value is used for IRI and CC) and also other implementations where multiple Correlation Identifier values may be used. The said method can also be used to correlate the IRI intercepted at S-CSCF, or AS, or AS/MRFC or even the P-CSCF even if those nodes use separate Correlation Identifier values. (In this respect, note that some implementations may adopt a concept of using different Correlation Identifier values at different nodes to avoid changes to the messages exchanged between the networks nodes within the IMS network).

As a part of this method according to some embodiments of the invention, a message called Correlation Message used to deliver the correlation information from the IMS network to the DF2 and then from the DF2 to the LEA may be introduced. Alternatively, in some embodiments of the invention, the Correlation Message may sometimes not be a standalone message. In these embodiments, the correlation information may be passed along with the IMS IRI messages to the LEA. If no IMS IRI message needs to be delivered, then an independent (standalone) Correlation Message may be sent. Depending on the implementation, the DF2 may or may not send all the correlation information every time it sends a IMS IRI message to the LEA.

Some embodiments of the invention provide a method that allows the DF2 to relate different identifier values that it receives from the IMS IRI or CTF to a particular IMS session. They allow an IMS session to have multiple media bearers each with own VoIP Correlation Number. Some embodiments of the invention do not require that the DF2 used to deliver the packet data IRI and DF2 used to deliver the IMS IRI be the same. As a matter of fact, the IMS VoIP interception can be independent of a packet data interception. According to some embodiments of the invention, the target may be involved in multiple concurrent IMS sessions each having separate distinct Correlation Ids both for IMS IRI and for the CC.

Accordingly, a data structure module for the delivery of correlation information to the LEA is defined. In order to maintain the backward compatibility, the existing data structure module defined in 3GPP TS 33.108 is enhanced to include the IMS VoIP specific variant.

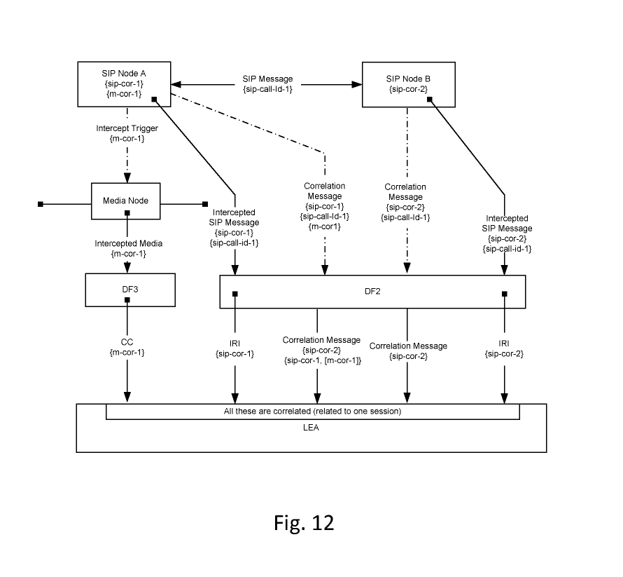

FIG. 12 illustrates an embodiment of the invention with two SIP nodes and on media node. This embodiment might be particularly useful to understand the concept of the invention.

In FIG. 12, two IMS nodes are shown - SIP Node A and SIP Node B. The SIP Node A uses sip-cor-1 as the IMS Correlation Number and SIP Node B uses the sip-cor-2 as the IMS Correlation Number. The sip-call-id-1 is the SIP Call Id used for the SIP messages exchanged between the SIP Node A and SIP

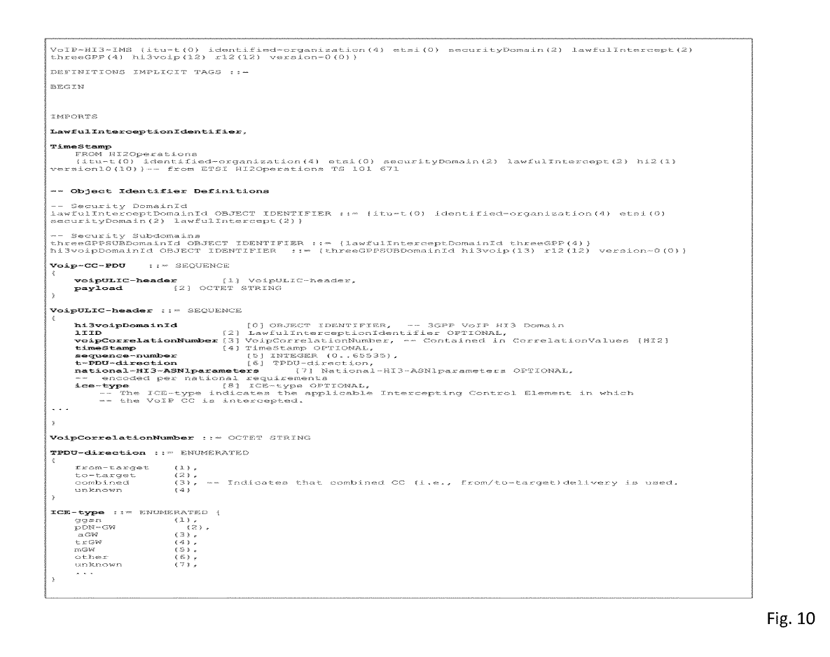

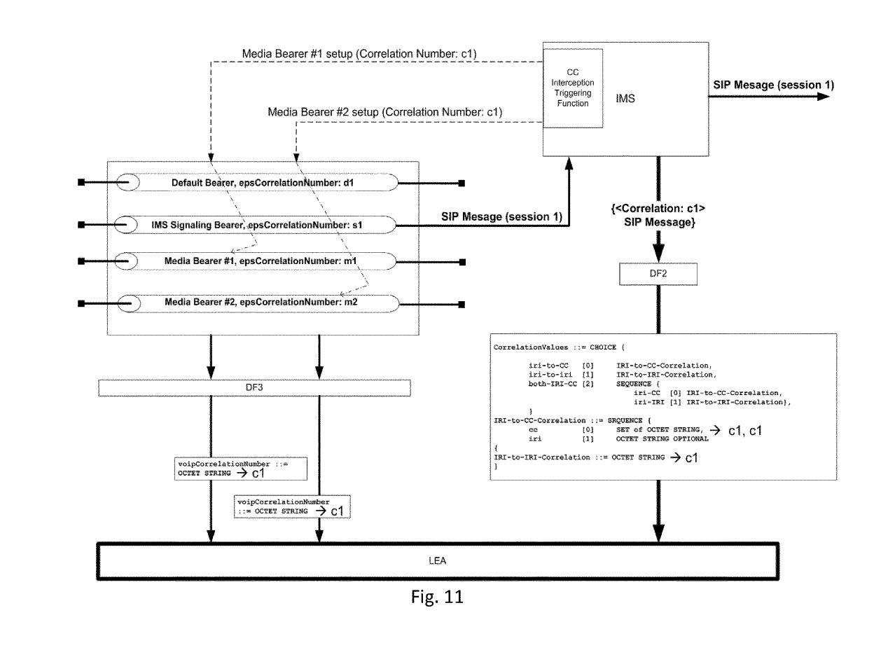

Node B. The SIP Node A provides the CC Intercept Triggering Function and assigns m-cor-1 as the Correlation Number to be used for the media and sends the same to the Media Node that provides the media interception within the Intercept Trigger. The Media Node includes m-cor-1 as the VoIP Correlation Number (see FIG. 10) in the CC delivered over the HI3 reference point to the LEA through the DF3.

As and when a Correlation Number is assigned, the corresponding SIP Node sends that Correlation Number (m-cor-1) in a message referred here as Correlation Message over the X2 interface to the DF2. The Correlation Message also contains the LIID (as currently implied by the 3GPP TS 33.108, not shown in FIG. 12) and the SIP Call Id. In the concepts illustrated in FIG. 12, the SIP Node A includes the sip-cor-1, m-cor-1 and sip-call-id-1 in the Correlation Message. The SIP Node B includes the sip-cor-2 and sip-call-id-1 in the Correlation Message. The DF2 generates a Correlation Message and delivers the same to the LEA. The IRI messages that come from the SIP Node B (contains sip-cor-2) are delivered to the LEA by DF2 as IRI messages with the Correlation Values containing sip-cor-2. The IRI messages that come from the SIP Node A (contains sip-cor-1) are delivered to the LEA by DF2 as IRI messages with the Correlation Values containing sip-cor-1.

For FIG. 12, one may assume that the SIP Node B sends the Correlation Message with sip-cor-2 to the DF2 first. At this time, if another Correlation Message was not previously received (that is the case, here), the Correlation Message that DF2 sends contains just the sip-cor-2. Then, as presumed in FIG. 12, the SIP Node A sends the Correlation Message with sip-cor-1 and m-cor-1 to the DF2. At this time, the DF2 constructs the Correlation Message that includes sip-cor-1 and sip-cor-2 as IMS Correlation Numbers and m-cor-1 as the VoIP Correlation Number for the CC.

In FIG. 12, the IRI messages received (if received) from the SIP Node A (containing sip-cor-1) are delivered to the LEA by DF2 as IRI messages with Correlation Values containing sip-cor-1. The CC received from the Media Node (containing m-cor-1) is delivered to the LEA by DF3 as CC with VoIP Correlation Number containing m-cor-1.

LEA uses the information received in the Correlation Message to correlate different IRI messages (may be intercepted at different nodes) and the CC. In this illustration of FIG. 12, the LEA treats that any IRI message received with sip-cor-1 and any IRI message received with sip-cor-2 are related to the same IMS session. Also, the LEA treats that the CC received with m-cor-1 is related to the same IMS session.

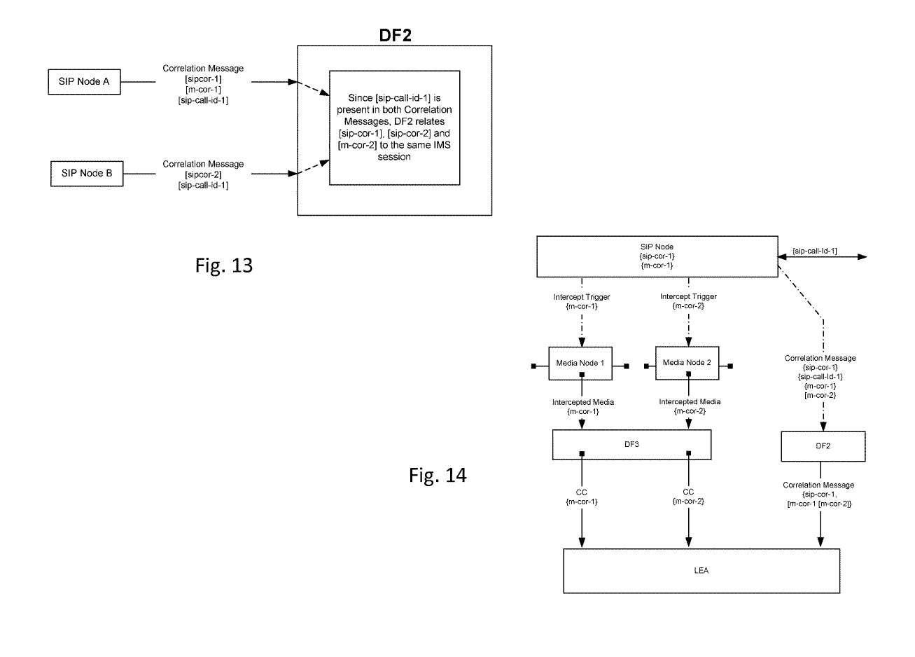

As shown in FIG. 13, the DF2 uses the SIP Call ID values received in the Correlation Message to associate the

Correlation Numbers received from different SIP Nodes to one IMS session. For example, when Correlation Message with [sip-cor-1], [m-cor-1], [sip-call-id-1] and later [sip-cor-2], [sip-call-id-1] are received, the DF2 uses the [sip-call-id-1] to associate a correlation between [sip-cor-2] and [sip-cor-1] & [m-cor-1].

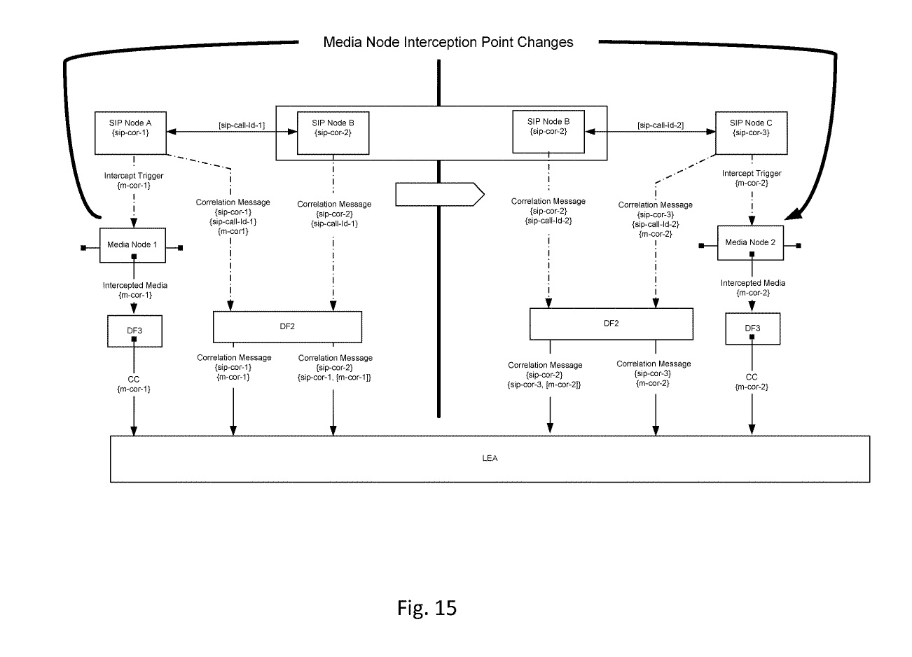

Embodiments of the invention work for basic IMS sessions and also for more complex IMS sessions such as call forwarding or IMS-based conferencing where the Media Node that provides the media interception may change during the session. A new Correlation Message may be sent to the LEA to update the correlation information. Embodiments of the invention also work if more than one media bearer is present in an IMS session. FIG. 14 and FIG. 15 illustrate such embodiments.

FIG. 14 shows an embodiment where an IMS session has two media bearers. In this example, the media is intercepted at the Media Node 1 and Media Node 2. The Correlation Message sent to the LEA contains information that allows the LEA to correlate the media packets received with VoIP Correlation Number m-cor-1 and the media packets received with the VoIP Correlation Number m-cor-2 to the IMS session that has the IMS Correlation Number sip-cor-1.

FIG. 15 shows an embodiment where the media interception point changes during an IMS session from Media Node 1 to Media Node 2. When the Media Node 1 is providing the media interception, the VoIP Correlation Number associated with the related CC is m-cor-1. The Correlation Message sent to the LEA allows the LEA to correlate the media packets received with the VoIP Correlation Number m-cor-1 with the IMS session that may utilize two IMS Correlation Numbers sip-cor-1 (SIP Node A) and sip-cor-2 (SIP Node B). When the media interception point changes to Media Node 2, the Correlation Information sent to the LEA allows the LEA to correlate the media packets received with the VoIP Correlation Number m-cor-2 with the IMS session that may utilize the IMS Correlation Numbers sip-cor-2 (SIP Node B) and sip-cor-3 (SIP Node C).

In the embodiment shown in FIG. 15, the SIP Node B does not include the sip-cor-1 and sip-call-id-1 in the Correlation Message sent to the DF2. This allows the DF2 to derive the new correlation information and thus send the new Correlation

Message comprising sip-cor-3, sip-call-id2, and m-cor-2.

In some embodiments of the invention, the SIP Node B does not remove sip-cor-1 and sip-call-id-1 (instead adds the sip-cor-3 and sip-call-id-3) in the Correlation Message that it sends to the DF2. Then, the DF2 may include both m-cor-1 (and sip-cor-1) and m-cor-2 (and sip-cor-3) in the Correlation Message sent to the LEA. In this case, the LEA may correlate any media packets received with VoIP Correlation Number m-cor-1 and any media packets received with VoIP Correlation Number m-cor-2 with the IMS session that may utilize the IMS Correlation Numbers sip-cor-2 (SIP Node B), sip-cor-3 (SIP Node C) and sip-cor-1 (SIP Node A). This case may be particularly applicable for certain scenarios such as conferencing and can be made applicable even if only one of the two Media Nodes provide the media interception. Because in the last case, even though the LEA may expect to receive the media packets with VoIP Correlation Number m-cor-1, since Media Node is not performing the media interception, no media packets with VoIP Correlation Number m-cor-1 are delivered to the LEA. Whether or not sip-cor-1 and sip-call-id-1 are removed from the Correlation message may depend on the particular implementation.

Embodiments of the invention may be used for all cases of IMS based VoIP interceptions - i.e., it can be used when the media interception is performed at the PDN-GW, GGSN, IMS-AGW, IM-MGW, TrGW and even the MRFP. The SIP Nodes that provide the IMS IRI interception can be P-CSCF, S-CSCF or AS/MRFC. The CTF can be P-CSCF, MGCF, IBCF or AS/MRFC. Embodiments of the invention may even apply if the MGCF and IBCF provide some IMS IRI events.

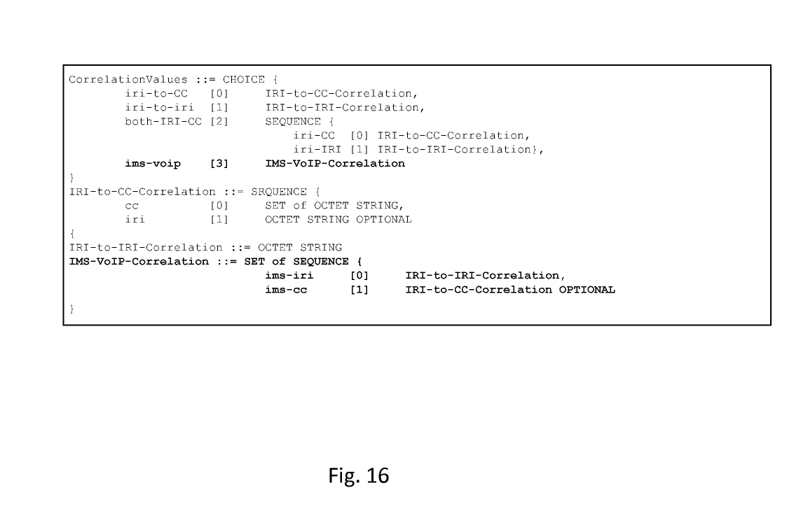

In order to accommodate the delivery of multiple Correlation Numbers to the LEA, the Correlation Values present within the conventional HI2 data structure module for IMS IRI messages requires some enhancements. A new data structure module according to embodiments of the invention may be preferably designed in such a way that it keeps the existing structure (to provide any backward compatibility needs) and adds the IMS VoIP specifics as a variant. In other words, a new CHOICE is added to the Correlation Values parameter to support the IMS VoIP scenario. Even though the VoIP is considered here, the new CHOICE, in principle, can be used for any IMS sessions. The concepts assume the recently approved stage 2 LI architecture definitions (based on NSN CRs) where the IMS provides a Correlation Identifier to be used for the delivery of the intercepted media packets (CC). Even though within NSN implementation only one Correlation Identifier is used as IMS Correlation Number and the VoIP Correlation Number, the data structure module defined here is applicable to implementations with plural Correlation Identifiers. The new data structure module definition is as shown in FIG. 16 (additions to the conventional data structure module defined in 3GPP TS 33.108 v 12.5.0 are in bold):

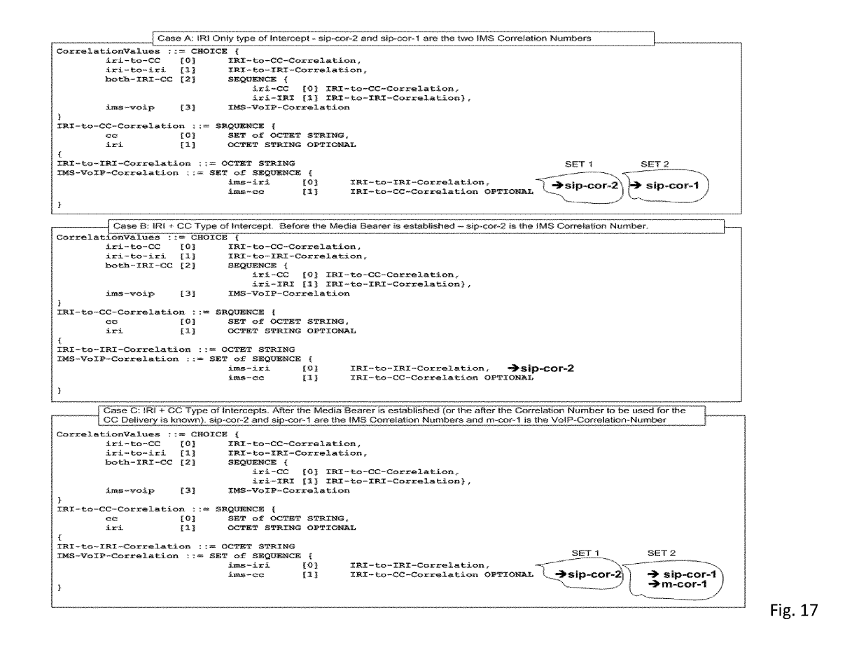

For the delivery of IMS VoIP Correlation Message or the IMS IRI message,
CHOICE
ims-voip [3] IMS-VoIP-Correlation may be be used. As shown in FIG. 16, IMS-VoIP-Correlation carries one or more set of IMS Correlation Number along with optional the VoIP Correlation Number. IMS Correlation Number occupies the ims-iri and VoIP Correlation Number occupies the ims-cc of IMS-VoIP Correlation Number. With the optional nature of ims-cc, the CHOICE of IMS-VoIP-Correlation can be used for IRI-only type of intercepts and IRI +CC type of intercepts. For example, in the example shown in FIG. 12, sip-core-2 can occupy ims-iri of one set and sip-cor-1 and m-cor-1 can occupy ims-iri and ims-cc of another set. An application of this data structure module according to an embodiment of the invention is illustrated in FIG. 17 below.

As shown in FIG. 17, ims-voip CHOICE of Correlation Values may be used for both IRI only and IRI+CC type of intercepts. The data structure module allows the delivery of Correlation Information before and after the media bearers are established. With ims-cc being a SET, the data structure module allows the use of a separate VoIP Correlation Number for each media bearer. By making IMS-VoIP-Correlation itself as a SET, the data structure module allows to have multiple SIP nodes intercepting the SIP messages. This may be particularly useful when AS/MRFC provides the interception of SIP messages for conference calls with S-CSCF providing the interception before the conference is invoked. Also, when edge-to-access media plane security is provided, the P-CSCF may have to provide the interception for a part of the SIP messages (e.g., the ones that carry the SDP information). This scenario is supported by embodiments of the invention, too.

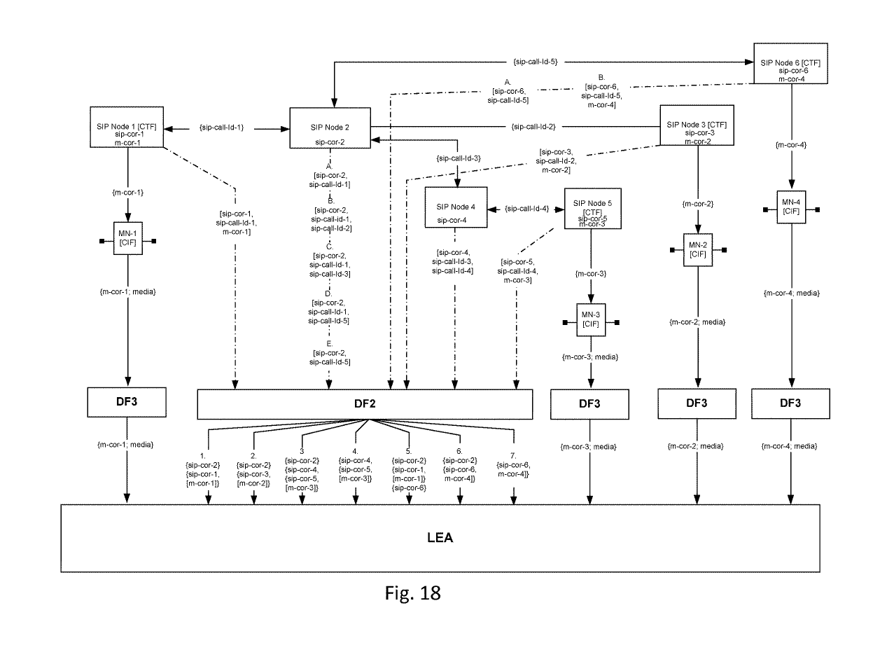

Hereinafter, some examples are provided that illustrate how embodiments of the invention handle some few IMS scenarios. FIG. 18 is a grand diagram that covers many scenarios.

FIG. 18 shows 6 SIP nodes (SIP Node 1 to SIP Node 6), all capable of providing the IMS IRI interception. In addition, FIG. 18 shows 4 Media Nodes (MN-1 to MN-4) used to provide the media interception. FIG. 18 shows the passing of the Correlation Numbers from the SIP Signalling Nodes to the DF2 and then from DF2 to the LEA. There are 7 scenarios illustrated in FIG. 18.

### Scenario 1

This may be a typical call origination scenario.

In this case, SIP Node 1 and SIP Node 2 are involved. SIP Node 1 and SIP Node 2 use sip-call-id-1 for the SIP messages exchanged between them. MN-1 (Media Node 1) provides the interception of the media. SIP Node 2 provides the interception of SIP messages. SIP Node 1 may also provide the interception of SIP messages, but it does not have to.

SIP Node 1 assigns VoIP Correlation Number (m-cor-1) and sends the same to the MN-1 along with the Intercept Trigger. SIP Node 1 uses the sip-cor-1 as the IMS Correlation Number. SIP Node 2 uses the sip-cor-2 as the IMS Correlation Number. SIP Node 1 sends the correlation information (sip-cor-1, m-cor-1 and sip-call-id-1) to the DF2. SIP Node 2 sends the correlation information (sip-cor-2 and sip-call-id-1) to the DF2 (marked with A in FIG. 18).

On the HI2 interface, the DF2 delivers the correlation information (sip-cor-2, sip-cor-1 and m-cor-1) to the LEA.

In some IMS originating call scenario, SIP Node 2 may also provide SIP Call ID associated with the outgoing SIP messages (towards the destination party) as a part of the correlation information to the DF2. This capability allows the SIP Node 2 to intercept the SIP messages sent or received from destination side of the call leg.

In a typical implementation, P-CSCF takes the role of SIP Node 1 and S-CSCF takes the role of SIP Node 2. MN-1 may be a PDN-GW, GGSN or an IMS-AGW.

### Scenario 2

This may be a typical call termination scenario.

In this case, SIP Node 2 and SIP Node 3 are involved. SIP Node 2 and SIP Node 3 use sip-call-id-2 for the SIP messages exchanged between them. In this case, sip-call-id-1 is presumed to be the SIP Call ID associated with the SIP messages received at SIP Node 2 from the originating side of the call. MN-2 (Media Node 2) provides the interception of the media. SIP Node 2 provides the interception of SIP messages. SIP Node 3 may also provide the interception of SIP messages, but it does not have to.

SIP Node 3 assigns VoIP Correlation Number (m-cor-2) and sends the same to the MN-2 along with the Intercept Trigger. SIP Node 3 uses the sip-cor-3 as the IMS Correlation Number. SIP Node 2 uses the sip-cor-2 as the IMS Correlation Number. SIP Node 3 sends the correlation information (sip-cor-3, m-cor-2 and sip-call-id-2) to the DF2. SIP Node 2 sends the correlation information (sip-cor-2, sip-call-id-2 and sip-call-id-1) to the DF2 (marked as B in FIG. 18).

On the HI2 interface, the DF2 delivers the correlation information (sip-cor-2, sip-cor-3 and m-cor-2) to the LEA.

In a typical implementation, P-CSCF takes the role of SIP Node 3 and S-CSCF takes the role of SIP Node 2. MN-2 can be a PDN-GW, GGSN or an IMS-AGW.

### Scenario 3

This may be a typical call forwarding scenario, where the target (person/entity to be intercepted) forwards the call.

In this case, SIP Node 2, SIP Node 4 and SIP Node 5 are involved. SIP Node 2 and SIP Node 4 use sip-call-id-3 for the SIP messages exchanged between them. SIP Node 4 and SIP Node 5 use sip-call-id-4 for the SIP messages exchanged between them. In this case, sip-call-id-1 is presumed to be the SIP Call ID associated with the SIP messages received at SIP Node 2 from the originating side of the call. MN-3 (Media Node 3) provides the interception of the media. SIP Node 2 provides the interception of SIP messages.

SIP Node 2 uses the sip-cor-2 as the IMS Correlation Number. SIP Node 4 uses the sip-cor-4 as the IMS Correlation Number. SIP Node 5 uses the sip-cor-5 as the IMS Correlation Number. SIP Node 2 sends the correlation information (sip-cor-2, sip-call-id-3 and sip-call-id-1) to the DF2 (marked as C in FIG. 18). SIP Node 4 sends the correlation information (sip-cor-4, sip-call-id-3 and sip-call-id-4) to the DF2. SIP Node 5 assigns VoIP Correlation Number (m-cor-3) and sends the same to the MN-3 along with the Intercept Trigger. SIP Node 5 sends the correlation information (sip-cor-5, m-cor-3 and sip-call-id-4) to the DF2.

On the HI2 interface, the DF2 delivers the correlation information (sip-cor-2, sip-cor-4, sip-cor-5 and m-cor-3) to the LEA.

In a typical implementation, S-CSCF takes the role of SIP Node 2. S-CSCF takes the role of SIP Node 4 (even though S-CSCF (as SIP Node 4) may not be the next hop SIP node from a S-CSCF (as SIP Node 2), from a correlation information collection perspective, such an assumption can be made). P-CSCF takes the role of SIP Node 5 and MN-3 can be a PDN-GW, GGSN or an IMS-AGW. For a call forwarding case, MN-3 may also be a IM-MGW (in this case the SIP Node 5 is MGCF) or a TrGW (in this case, the SIP Node 5 may be IBCF).

### Scenario 4

This may be a typical call forwarding scenario where the forwarded-to party happens to be the target (i.e. the person/entity to be intercepted).

In this case, SIP Node 2, SIP Node 4, and SIP Node 5 are involved. From a SIP signalling perspective, this case is same as the case 3. The difference is that in this case the forwarded-to-party is the target whereas in case 3, the forwarding party is the target. Therefore, in case 3 SIP Node 2 provides the IMS IRI interception whereas in this case SIP Node 4 provides the IMS IRI interception.

SIP Node 2 and SIP Node 4 use sip-call-id-3 for the SIP messages exchanged between them. SIP Node 4 and SIP Node 5 use sip-call-id-4 for the SIP messages exchanged between them. MN-3 (Media Node 3) provides the interception of the media. SIP Node 4 provides the interception of SIP messages.

SIP Node 4 uses the sip-cor-4 as the IMS Correlation Number. SIP Node 5 uses the sip-cor-5 as the IMS Correlation Number.

SIP Node 4 sends the correlation information (sip-cor-4, sip-call-id-3 and sip-call-id-4) to the DF2. SIP Node 5 assigns VoIP Correlation Number (m-cor-3) and sends the same to the MN-3 along with the Intercept Trigger. SIP Node 5 sends the correlation information (sip-cor-5, m-cor-3 and sip-call-id-4) to the DF2.

On the HI2 interface, the DF2 delivers the correlation information (sip-cor-4, sip-cor-5 and m-cor-3) to the LEA.

When this case is compared to case 3, MN-3 in both cases provides the media interception. However, the LIID happens to be different and hence, the LEA is able to associate the received CC with a particular IMS session. In a typical implementation, the MN-3 may provide two copies of the intercepted media to the LEA because the interception is done for two different targets. However, this particular point (i.e., whether one vs. two copies of media packets) is not of relevance in the present context.

In a typical implementation, S-CSCF takes the role of SIP Node 2. S-CSCF takes the role of SIP Node 4 (even though S-CSCF (as SIP Node 2) may not be the previous hop SIP node to the S-CSCF (as SIP Node 4), from a correlation information collection perspective, such an assumption can be made). P-CSCF takes the role of SIP Node 5 and MN-3 can be a PDN-GW, GGSN or an IMS-AGW.

### Scenario 5

This may be a typical Conferencing scenario.

In this case, SIP Node 1, SIP Node 2 and SIP Node 6 are involved. SIP Node 1 and SIP Node 2 use sip-call-id-1 for the SIP messages exchanged between them. SIP Node 2 and SIP Node 6 use sip-call-id-5 for the SIP messages exchanged between them. MN-1 (Media Node 1) provides the interception of the media. SIP Node 2 and SIP Node 6 provide the interception of SIP messages. SIP Node 1 may also provide the interception of SIP messages, but it does not have to.

SIP Node 1 assigns VoIP Correlation Number (m-cor-1) and sends the same to the MN-1 along with the Intercept Trigger. SIP Node 1 uses the sip-cor-1 as the IMS Correlation Number. SIP Node 2 uses the sip-cor-2 as the IMS Correlation Number. SIP Node 6 uses the sip-cor-6 as the IMS Correlation Number. SIP Node 1 sends the correlation information (sip-cor-1, m-cor-1 and sip-call-id-1) to the DF2. SIP Node 2 sends the correlation information (sip-cor-2, sip-call-id-1 and sip-call-id-5) to the DF2 (marked as D in FIG. 18). SIP Node 6 sends the correlation information (sip-cor-6, sip-call-id-5) to the DF2.

On the HI2 interface, the DF2 delivers the correlation information (sip-cor-2, sip-cor-1, sip-cor-6 and m-cor-1) to the LEA.

In a typical implementation, P-CSCF takes the role of SIP Node 1 and S-CSCF takes the role of SIP Node 2. AS/MRFC can take the role of SIP Node 6. MN-1 can be a PDN-GW, GGSN or an IMS-AGW.

### Scenario 6

This may be another Conferencing scenario. The scenario is very similar to scenario 5 except that here the media interception is done at the Media Node 4 (MN-4). And also, in this case, SIP Node 1 does not provide any IMS IRI interception. The case where SIP Node 1 also providing the IMS IRI interception and MN-4 providing the media interception can be another case by itself (not illustrated here).

In this case, SIP Node 2 and SIP Node 6 are involved. SIP Node 2 and SIP Node 6 use sip-call-id-5 for the SIP messages exchanged between them. MN-4 (Media Node 4) provides the interception of the media. SIP Node 2 and SIP Node 6 provide the interception of SIP messages.

SIP Node 2 uses the sip-cor-2 as the IMS Correlation Number. SIP Node 6 uses the sip-cor-6 as the IMS Correlation Number. SIP Node 2 sends the correlation information (sip-cor-2 and sip-call-id-5) to the DF2 (marked as E in FIG. 18). SIP Node 6 sends the correlation information (sip-cor-6, sip-call-id-5, m-cor-4) to the DF2.

On the HI2 interface, the DF2 delivers the correlation information (sip-cor-2, sip-cor-6 and m-cor-4) to the LEA.

In a typical implementation, S-CSCF takes the role of SIP Node 2. AS/MRFC can take the role of SIP Node 6. MRFP takes the role of MN-4.

As an implementation alternative, the SIP Node 2 can include sip-call-id-1 in the correlation information that it delivers to the DF2. This allows the SIP Node 1 also provide IMS IRI interception. However, in this case, m-cor-1 may also be included in the correlation information. But, this approach will have one of the two outcomes: Either the LEA receive media packets from MN-1 and MN-4 (duplicate call content reception) or IMS network would stop the interception at MN-1 and hence, even if the LEA is prepared to receive the media packets with m-cor-1 as the VoIP Correlation Number, it won't receive any.

### Scenario 7

This may be another Conferencing scenario. In this case, only SIP Node 6 provides the IMS IRI interception. The media interception is performed at the MN-4 as in case 6.

In this case, SIP Node 6 is involved. SIP Node 6 uses sip-call-id-5 for the SIP messages that it receives. SIP Node 6 uses the sip-cor-6 as the IMS Correlation Number. SIP Node 6 sends the correlation information (sip-cor-6, sip-call-id-5, m-cor-4) to the DF2. Since SIP Node 6 is the sole IMS IRI interception point, sip-call-id-5 can be skipped from reporting to the DF2. That may be an implementation alternative.

On the HI2 interface, the DF2 delivers the correlation information (sip-cor-6 and m-cor-4) to the LEA.

In a typical implementation, AS/MRFC can take the role of SIP Node 6 and MRFP takes the role of MN-4.

From an implementation perspective, some alternatives do exist for embodiments of the invention, e.g.:
1. The Correlation Message can be an independent message by itself.
2. The Correlation Message can be a part of the IMS IRI message.
3. IMS IRI may include the entire Correlation Information.
4. DF2 may choose to have a method of using just one IMS Correlation Number even if the IMS SIP Nodes use a separate individual IMS Correlation Numbers.
5. Once the correlation information is delivered, the subsequent IMS IRI messages delivered over the X2 interface may just carry the SIP Call ID or just carry the IMS Correlation Number to let the DF2 to determine the correlation based on the previously received correlation information.

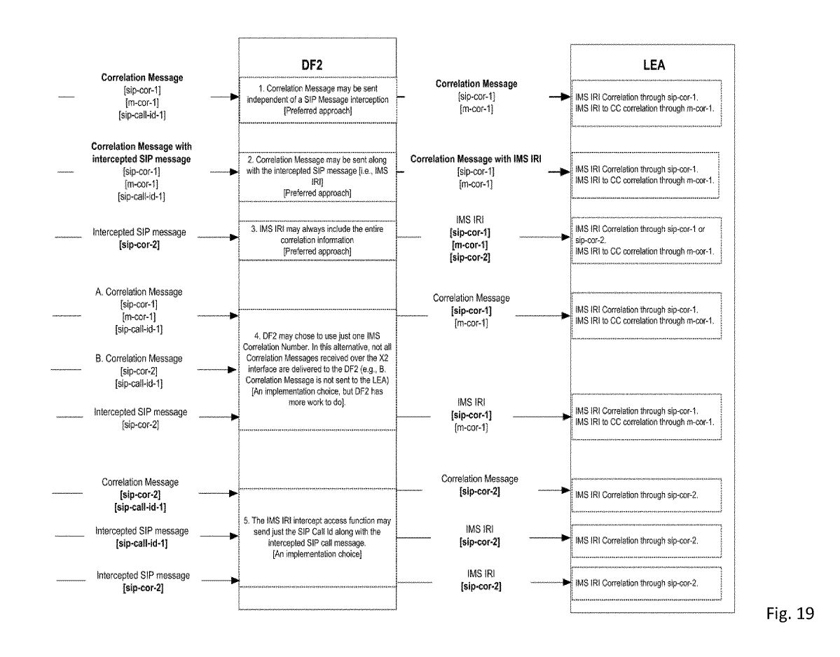

These 5 implementation alternatives are illustrated in FIG. 19.

FIG. 19 shows that a Correlation Message may be delivered from DF2 to LEA either independently (alternative 1) or along with the delivery of an intercepted SIP message (alternative 2).

While alternatives 1 and 2 are related to the forming of the correlation message to LEA, alternatives 3 to 5 also consider handling of intercepted SIP messages at DF2.

FIG. 19 also shows the option where the DF2 includes the entire correlation information in all the delivered IMS IRI messages (alternative 3). In the example shown in FIG. 19, DF2 receives an intercepted SIP message with sip-cor-2 as correlation identifier. However, since DF2 knows, e.g. from a previously received correlation message from a SIP node according to one of the alternatives 1 and 2, that sip-cor-1, sip-cor-2, and m-cor-1 are correlated. Therefore, DF2 adds, when forwarding the intercepted SIP message to LEA (LEMF), sip-cor-1 and m-cor-1 to sip-cor-2 such that the forwarded intercepted SIP messages comprises the correlation ids sip-cor-1, sip-cor-2, and m-cor-1. In particular if this is done for each intercepted SIP message, correlation at LEA is simplified.

FIG. 19 also shows the case where the DF2 chooses to use one IMS Correlation Number (Alternative 4). DF2 is informed about the correlation of sip-cor-1, sip-cor-2, and m-cor-1 from the SIP nodes, e.g. according to alternatives 1 or 2. That is, the SIP nodes may use the same or different correlation ids. Nevertheless, regardless from which SIP nodes (with corresponding correlation id) DF2 receives an interception message, DF2 forwards the interception message always with a same correlation id (in the example of Alternative 4 of FIG. 19: sip-cor-1). Accordingly, the correlation message from DF2 to LEA comprises only this one SIP correlation id (plus media correlation id(s) such as m-cor-1) such that correlation at LEA is relatively easy.

Alternative 5 is a variant of Alternatives 4 and 5 related to the X2 interface between SIP node(s) and DF2. In FIG. 19, a variant of Alternative 4 is shown, but the Alternative 5 may be applied to Alternative 3, too. It shows the case where SIP nodes may provide the intercepted SIP messages with different ids, namely an IMS correlation identifier (sip-cor-2), a SIP call Id (sip-call-id-1), or both. Since DF2 is previously informed about the correlation of sip-cor-2 and sip-call-1, e.g. according to one of Alternatives 1 and 2, DF2 is able to derive the IMS Correlation Number even if it receives just the SIP Call Id, or just the IMS Correlation Number, or both in the intercepted SIP messages. It may then forward the intercepted SIP message to LEA according to one of Alternatives 3 and 4.

Among these alternatives, sending of the Correlation Message along with IMS IRI message and DF2 including the entire correlation information in the IRI messages may be the preferred alternative.

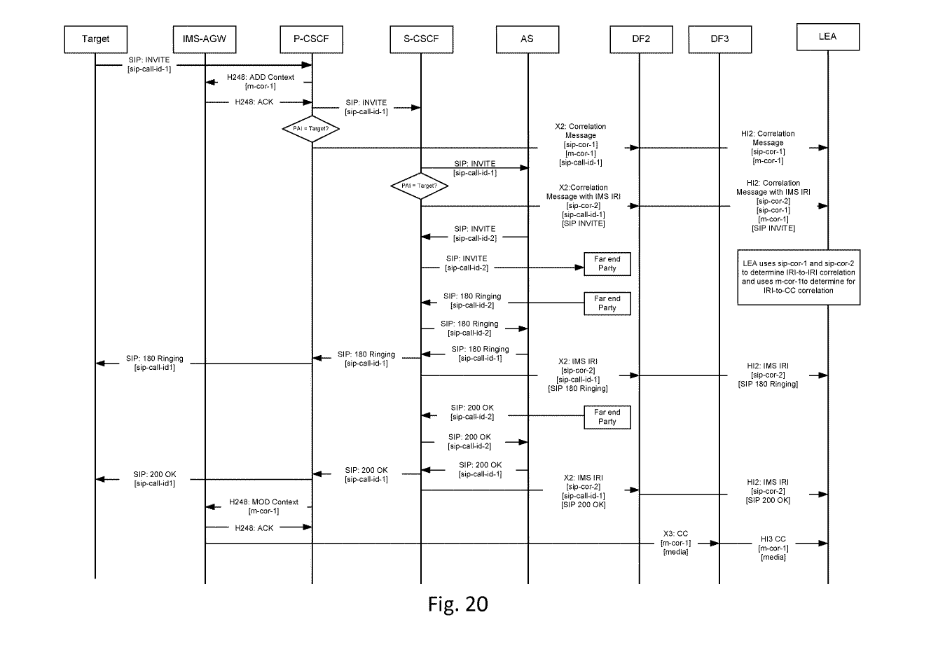

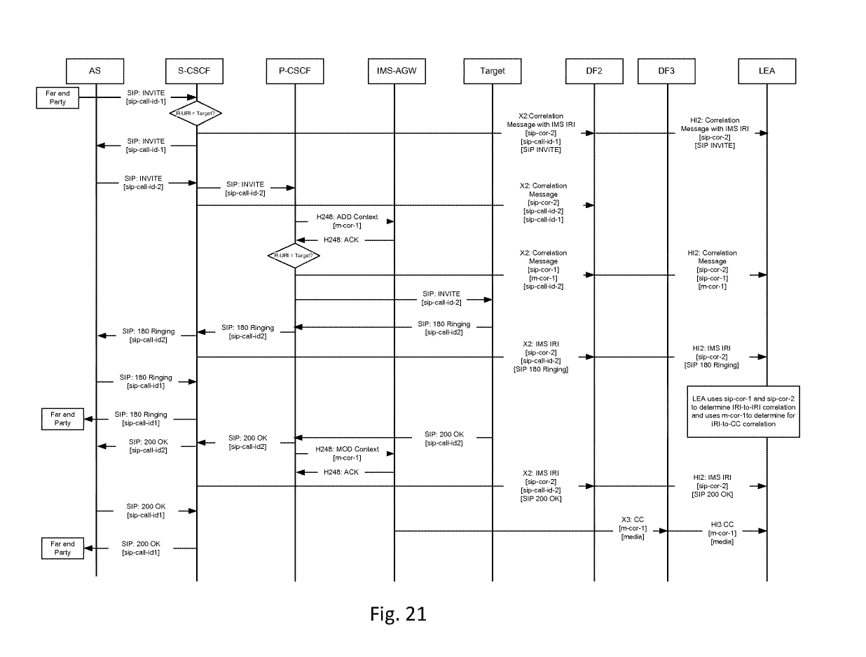

Two call flows are shown in FIG. 20 and FIG. 21 to illustrate embodiments of the invention.

FIG. 20 shows a call origination scenario. Here, the P-CSCF upon receiving the SIP INVITE message from the Target interacts with the IMS-AGW and sends the intercept trigger which includes the m-cor-1 to be used as the Correlation Id when the intercepted media is delivered to the LEA via the DF3. Since, SIP INVITE (from P-CSCF) is not delivered to the

LEA, the P-CSCF sends the Correlation Message with sip-cor-1, m-cor-1 and sip-call-id-1. The DF2 forwards this Correlation Message to the LEA with the correlation information containing sip-cor-1 and m-cor-1.

The S-CSCF intercepts the SIP INVITE and sends the Correlation Message with IMS IRI message and contains the sip-cor-2 and sip-call-id-1. The DF2 delivers the Correlation Message with the IMS IRI message and contains the sip-cor-2, sip-cor-1 and m-cor-1.

In this call flow, the subsequent SIP messages delivered contain just the sip-cor-2. The CC contains m-cor-1 as Correlation Number. Based on the previously received Correlation Message, the LEA is able to correlate all the IRI messages and the CC with the IRI messages.

FIG. 21 shows a call termination scenario. Here, the S-CSCF intercepts the incoming SIP INVITE and sends the Correlation

Message with IMS IRI message and contains the sip-cor-2 and sip-call-id-1. The DF2 delivers the Correlation Message with the IMS IRI message and contains the sip-cor-2. When the SIP INVITE comes back from the AS with a different SIP Call Id, the S-CSCF sends a Correlation Message to the DF2 and contains sip-cor-2 and sip-call-id-2. The DF2 which is aware of the sip-cor-2 notes the association between sip-call-id-1 and sip-call-id-2 and sip-cor-2. Since, the correlation information pertaining to the sip-cor-2 is already reported to the LEA, DF2 does not send any new Correlation Message here.

The P-CSCF, upon receiving the SIP-INVITE from the S-CSCF, interacts with the IMS-AGW and sends the intercept trigger which includes the m-cor-1 to be used as the Correlation Id when the intercepted media is delivered to the LEA via the DF3. Since, this SIP INVITE (from P-CSCF) is not delivered to the LEA, the P-CSCF sends the Correlation Message with sip-cor-1, m-cor-1 and sip-call-id-1. The DF2 forwards this Correlation Message to the LEA with the correlation information containing sip-cor-2, sip-cor-1 and m-cor-1.

In this call flow, the subsequent SIP messages delivered contain just the sip-cor-2. The CC contains m-cor-1 as Correlation Number. Based on the previously received Correlation Message, the LEA is able to correlate all the IRI messages and the CC with the IRI messages.

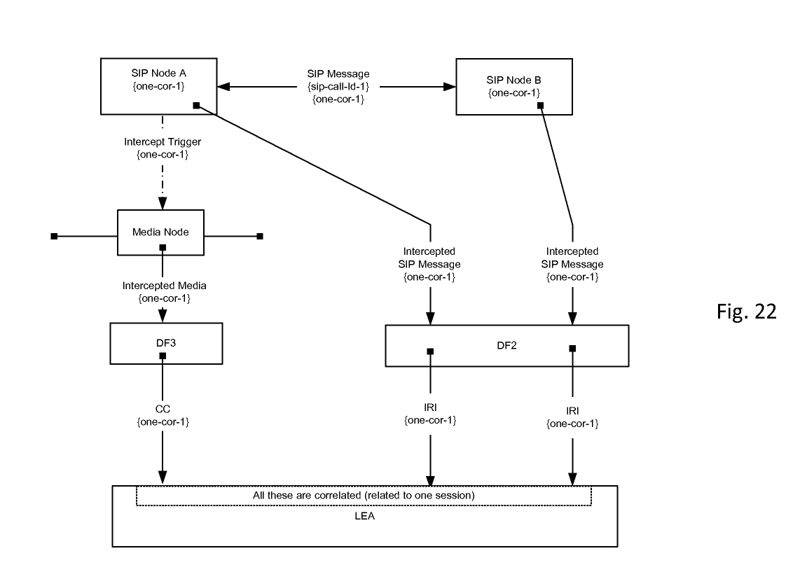

FIG. 22 illustrates an embodiment of the invention based on conventional NSN implementation. As noted earlier, in the NSN implementation, one Correlation Id is used for media as well as SIP Messages. This single Correlation Id is exchanged between the SIP nodes in a proprietary way.

FIG. 22 shows a case where one-cor-1 is used as the Correlation Id for the delivery of IMS IRI and the CC. In this approach, the Correlation Message is not really required since only one Correlation Id is used. However, a method is required to transport this Correlation Id within the IMS network from one node to another. Furthermore, all SIP Nodes have to be aware of the case and have to have the capability to pass that Correlation Id to the next hop. However, in this approach, if multiple media bearers are setup for an IMS session, then since single Correlation Id is used, additional steps are required to isolate and associate the intercepted media packets to a particular bearer. The new data structure module according to embodiments of the invention may be used to pass on the single Correlation Id value to the LEA on the HI2 interface.

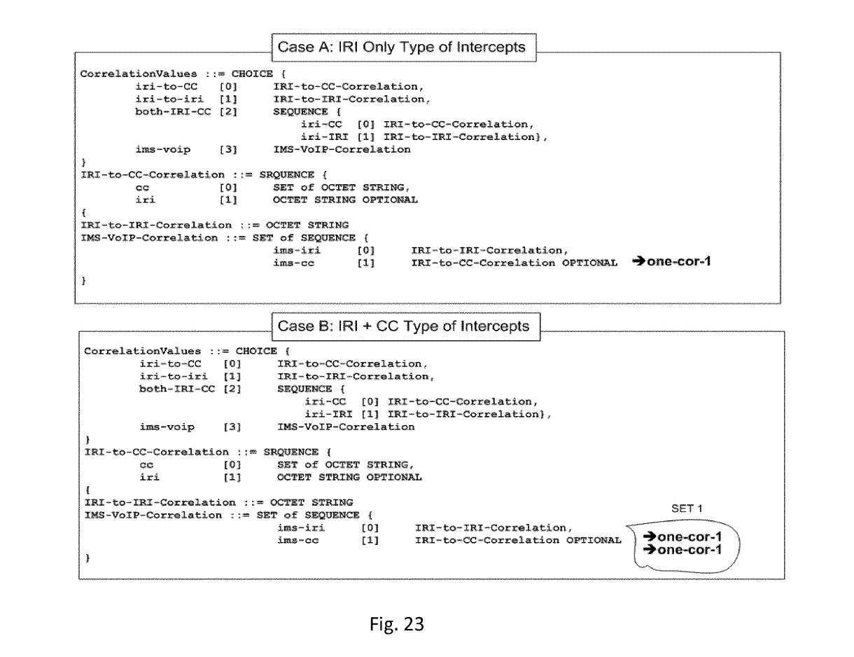

FIG. 23 illustrates how to pass this Correlation Id using the new data structure module according to embodiments of the invention.

As shown in FIG. 23, ims-voip CHOICE of Correlation Values can still be used for both IRI only and IRI+CC type of intercepts. Since only one Correlation Id is used here, the delivery of correlation information before and after the media bearer is not impacted. Since only one Correlation Id is used, only one SET of IMS-VoIP-Correlation is required.

The following section compares the new data structure module according to embodiments of the invention with the conventional data structure module.

If one Correlation Id is used for IMS IRI and for CC, then the previous data structure module can still be used. However, as noted hereinabove, the use of single Correlation Id has some limitations.

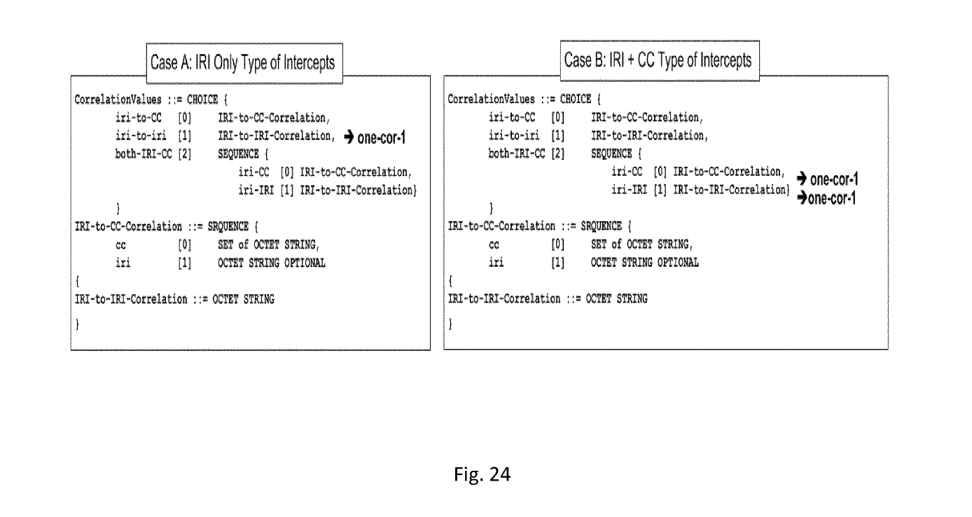

FIG. 24 explains the use of previous data structure module for the single Correlation Id use-case.

One drawback in the previous data structure module is that the iri-cc is not optional. Therefore, the DF2 has to indicate that one-cor-1 is the Correlation Id for the CC even before a media bearer is setup and established.

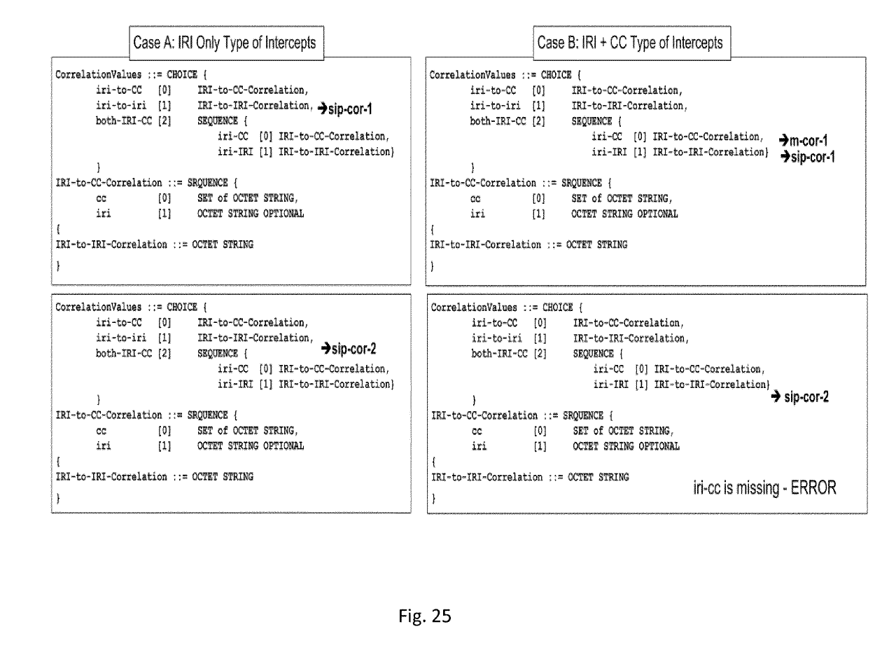

If multiple Correlation Ids are used by different SIP Nodes, then the previous data structure module cannot be used for some scenarios, as illustrated in FIG. 25.

In the example illustrated in FIG. 25, two SIP Nodes may provide the interception of SIP messages. The sip-cor-1 and sip-cor-2 are reported separately and there is no way for a LEA to determine that sip-cor-1 and sip-cor-2 are to be correlated to the same IMS session. Furthermore, sip-cor-2 cannot be reported as shown for IRI+CC type of intercepts because iri-cc is mandatory and may not be available for the SIP node that uses sip-cor-2. However, for implementations that use one IMS Correlation Number on the HI2 interface (even if multiple nodes provide the IMS IRI interception) but a different VoIP Correlation Number for the CC, the existing structure could work fine, if the VoIP Correlation Number is known at the beginning of the session establishment. Otherwise, that implementation will have to use two different CHOICE values (iri-to-iri before the VoIP Correlation Number is known and both-IRI-CC once the VoIP Correlation Number is known) because iri-cc in both-IRI-CC is mandatory. The validity of such an operation would depend on whether or not the collection equipment at the LEA can handle such IRI messages.

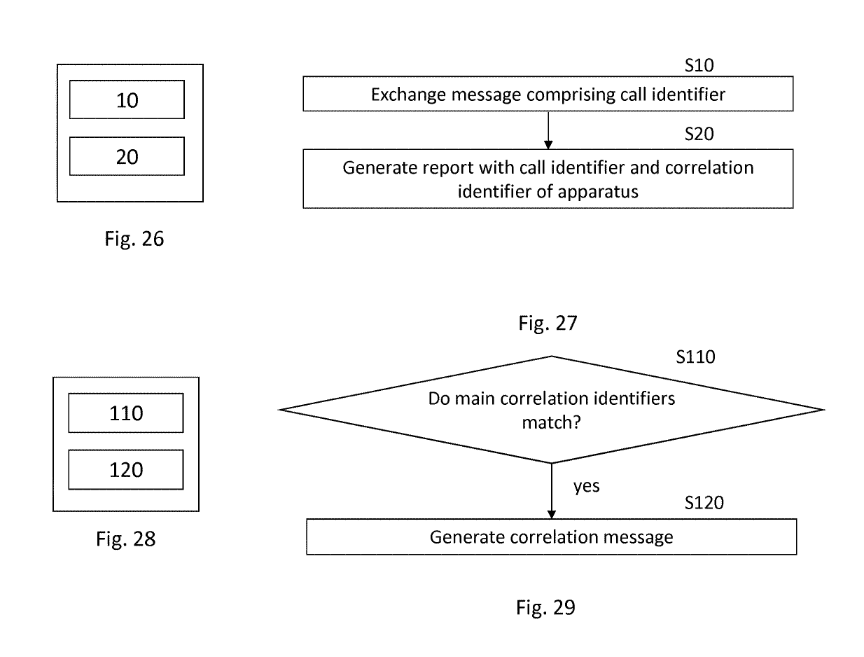

FIG. 26 shows an apparatus according to an embodiment of the invention. The apparatus may be an IMS node or an element thereof. FIG. 27 shows a method according to an embodiment of the invention. The apparatus according to FIG. 26 may perform the method of FIG. 27 but is not limited to this method. The method of FIG. 27 may be performed by the apparatus of FIG. 26 but is not limited to being performed by this apparatus.

The apparatus comprises exchanging means 10 and report generating means 20.

The exchanging means 10 exchanges a first message of a session initiation protocol related to a call with a control device (such as a SIP node) (S10). The first message comprises a call identifier of the call.

The report generating means 20 generates a report on an interception related information comprising a correlation identifier of the apparatus and the call identifier (S20). The interception related information (IRI) may be based on the first message but it may be based on other SIP messages exchanged in connection to the call instead. I.e. IRI provides information about the respective SIP message.

In some embodiments of the invention, a report forwarding means may forward the report to a delivery function device such as DF2.

FIG. 28 shows an apparatus according to an embodiment of the invention. The apparatus may be a delivery function such as a DF2 or an element thereof. FIG. 29 shows a method according to an embodiment of the invention. The apparatus according to FIG. 28 may perform the method of FIG. 29 but is not limited to this method. The method of FIG. 29 may be performed by the apparatus of FIG. 28 but is not limited to being performed by this apparatus.

The apparatus comprises first match checking means 110 and generating means 120.

The first match checking means 110 checks if a value of a main correlation identifier comprised in a first correlation message received from a first node and a value of the main correlation identifier comprised in a second correlation message received from a second node different from the first node are the same (S110). The main correlation identifier may be a SIP-call id. The first correlation message additionally comprises a first secondary correlation identifier, and the second correlation message additionally comprises a second secondary correlation identifier. Each of the secondary correlation identifiers may be e.g. an identifier of media or an identifier of a SIP node.

The generating means 120 generates, if the value of the main correlation identifier comprised in the first correlation message and the value of the main correlation identifier comprised in the second correlation message are the same, a main correlation message comprising at least one of the first secondary correlation identifier and the second secondary correlation identifier (S120). The main correlation message may or may not comprise the main correlation identifier.

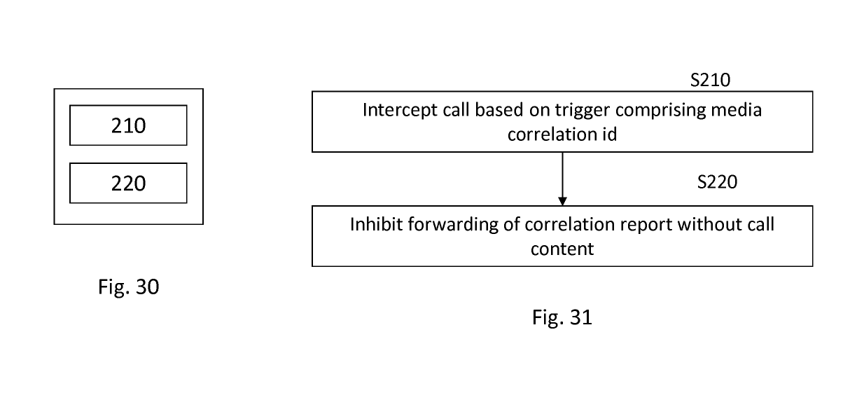

FIG. 30 shows an apparatus according to an embodiment of the invention. The apparatus may be a media function an element thereof. FIG. 31 shows a method according to an embodiment of the invention. The apparatus according to FIG. 30 may perform the method of FIG. 31 but is not limited to is method. The method of FIG. 31 may be performed by the apparatus of FIG. 30 but is not limited to being performed by this apparatus.

The apparatus comprises intercepting means 210 and inhibiting means 220.

The intercepting means 210 intercepts a call content of a call of a session initiation protocol after having received a trigger comprising a media correlation identifier of a media transporting the call (S210).

The inhibiting means 220 inhibits the apparatus from providing a correlation message comprising the media correlation identifier to a delivery function such as DF2 if the correlation message does not comprise the call content (S220). For example, the apparatus may not have a function to provide a correlation message without call content to a delivery function.

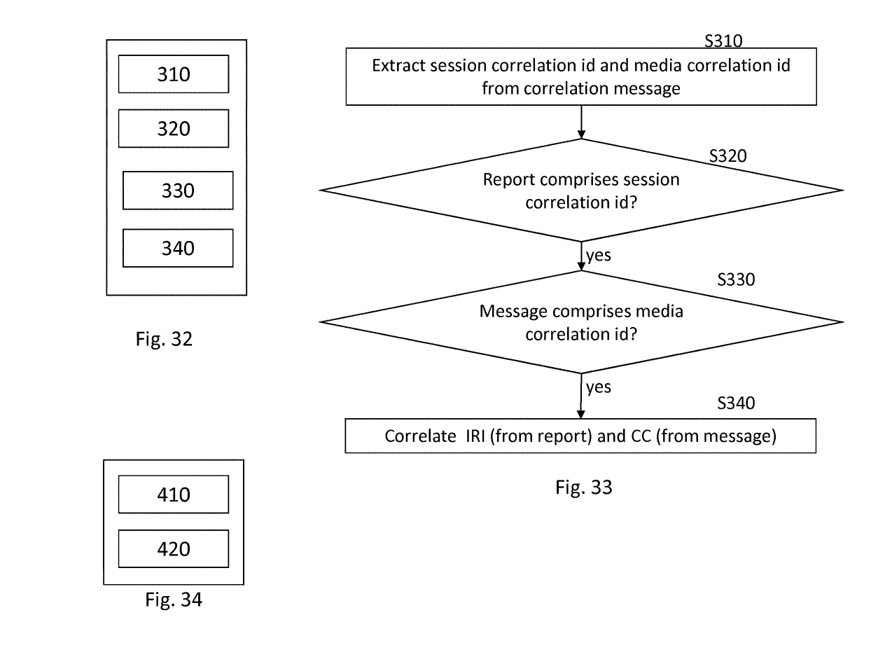

FIG. 32 shows an apparatus according to an embodiment of the invention. The apparatus may be a LEMF or an element thereof. FIG. 33 shows a method according to an embodiment of the invention. The apparatus according to FIG. 32 may perform the method of FIG. 33 but is not limited to is method. The method of FIG. 33 may be performed by the apparatus of FIG. 32 but is not limited to being performed by this apparatus.

The apparatus comprises extracting means 310, session evaluating means 320, media evaluating means 330, and correlating means 340.

The extracting means 310 extracts a session correlation identifier and a media correlation identifier from a received correlation message (S310). For example, the correlation message may be received from a delivery function such as DF2.

The session evaluating means 320 evaluates if a received report comprises the session correlation identifier (S320). In addition, the report comprises an interception related information. For example, the report may be received from a delivery function such as DF2. It may be the same DF2 or a different DF2 than the DF2 from which the correlation message is received.

The media evaluating means 330 evaluates if a received message comprises the media correlation identifier (S330). In addition, the first message comprises a call content. For example, the message may be received from a delivery function such as DF3.

The sequence of steps S320 and S330 may be interchanged, or these steps may be performed in parallel.

If the report comprises the session correlation identifier (S320: “yes”) and the message comprises the media correlation identifier (S330: “yes”) the correlating means 340 correlates the interception related information and the call content (S340).

FIG. 34 shows an apparatus according to an embodiment of the invention. The apparatus comprises at least one processor 410, at least one memory 420 including computer program code, and the at least one processor, with the at least one memory and the computer program code, being arranged to cause the apparatus to at least perform at least one of the methods according to FIGS. 27, 29, 31, and 33.

Within this application, sometimes it is referred to VoIP. VoIP is one of the most prominent SIP applications. However, the application and the embodiments of the invention are applicable to other SIP applications, too.

Embodiments of the invention may be employed in other cases, too. One example is Single Radio Voice Call Continuity (SR-VCC) where different access network (packet core and CS-domain) are involved within a session. The standard bodies are yet to define how LI would work on SR-VCC. Embodiments of the invention solve the generic problem of correlation for this configuration, too.

The terms Correlation ID and Correlation Number are used synonymously in this application. The term Correlation Number is used in the 3GPP specifications, to which the present application refers quite often.

The term “bearer” is used in the EPS and the same is known as a PDP context in the GPRS/UMTS network. For the present application, the term “bearer” should be taken as a bearer in

EPS or a PDP context in GPRS/UMTS. It may also mean a corresponding item (“bearer”) in other network technologies.

Embodiments of the invention may be employed in a LTE-A network. They may be employed also in other mobile and fixed networks such as CDMA, EDGE, LTE, UTRAN, WiFi networks, etc, where SIP is implemented.

A terminal may be a user equipment such as a mobile phone, a smart phone, a PDA, a laptop, a tablet PC, or any other device which may be connected to the respective mobile network.

One piece of information may be transmitted in one or plural messages from one entity to another entity. Each of these messages may comprise further (different) pieces of information.

Names of network elements, protocols, and methods are based on current standards. In other versions or other technologies, the names of these network elements and/or protocols and/or methods may be different, as long as they provide a corresponding functionality.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software.

According to the above description, it should thus be apparent that exemplary embodiments of the present invention provide, for example a SIP node or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that exemplary embodiments of the present invention provide, for example a delivery function such as DF2, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1-50. (canceled)

51. Apparatus, comprising
first match checking means adapted to check if a value of a main correlation identifier comprised in a first correlation message received from a first node and a value of the main correlation identifier comprised in a second correlation message received from a second node different from the first node are the same, wherein
the first correlation message additionally comprises a first secondary correlation identifier, and
the second correlation message additionally comprises a second secondary correlation identifier; and the apparatus further comprises
generating means adapted to generate, if the value of the main correlation identifier comprised in the first correlation message and the value of the main correlation identifier comprised in the second correlation message are the same, a main correlation message comprising the first secondary correlation identifier.

52. The apparatus according to claim 51, wherein the generating means is adapted to generate the main correlation message such that it comprises additionally the second secondary correlation identifier.

53. The apparatus according to claim 51, wherein
one of the first correlation message and the second correlation message additionally comprises an interception related information, and
the generating means is adapted to include the interception related message into the main correlation message.

54. The apparatus according to claim 52, further comprising
first analyzing means adapted to analyze if a received first interception message comprising a first interception related information comprises one of the first secondary correlation identifier, the second secondary correlation identifier, and the main correlation identifier;
first forwarding means adapted to forward the first interception related information together with the first secondary correlation identifier and the second secondary correlation identifier if the received first interception message comprises one of the first secondary correlation identifier and the second secondary correlation identifier.

55. The apparatus according to claim 51, further comprising
first inhibiting means adapted to inhibit the generating means from including the second secondary correlation identifier in the main correlation message;
second analyzing means adapted to analyze if a received second interception message comprising a second interception related information comprises one of the first secondary correlation identifier, the second secondary correlation identifier, and the main correlation identifier;
forwarding means adapted to forward the second interception related information together with the first secondary correlation identifier if the received interception message comprises one of the first secondary correlation identifier and the second secondary correlation identifier;
second inhibiting means adapted to inhibit the forwarding means from forwarding the second secondary correlation identifier with the second interception related information.

56. The apparatus according to claim 51, further comprising
multiplicity checking means adapted to check if the second correlation message comprises two values of the main correlation identifier;
second match checking means adapted to check if a value of the main correlation identifier comprised in a third correlation message received from a third node different from the first node and different from the second node is the same as one of the values of the main correlation identifier comprised in the second correlation message; wherein
the third correlation message additionally comprises a third secondary correlation identifier; and
the generating means is adapted to generate, if the value of the main correlation identifier comprised in the third correlation message is the same as one of the values of the main correlation identifier comprised by the second correlation message, the main correlation message additionally comprising the third secondary correlation identifier.

57. The apparatus according to claim 51, wherein one of the first and second secondary correlation identifiers is an identifier of a media transporting call content of the call.

58. The apparatus according to claim 51, wherein one of the first and second secondary correlation identifiers is an identifier of a message of a session initiation protocol related to the call.

59. The apparatus according to claim 51, wherein the main correlation identifier is a call identifier of a session initiating protocol session.

60. The apparatus according to claim 51, wherein the main correlation message does not comprise the main correlation identifier.

61. Apparatus, comprising
extracting means adapted to extract a first session correlation identifier and a first media correlation identifier from a received correlation message;
first session evaluating means adapted to evaluate if a received first report comprises the first session correlation identifier, wherein a first interception related information is comprised in the first report;
first media evaluating means adapted to evaluate if a received first message comprises the first media correlation identifier, wherein a first call content is comprised in the first message;
correlating means adapted to correlate the first interception related information and the first call content if the first report comprises the first session correlation identifier and the first message comprises the first media correlation identifier.

62. The apparatus according to claim 61, wherein
the extracting means is adapted to extract a second session correlation identifier different from the first session correlation identifier from the correlation message; and the apparatus comprises
second session evaluating means adapted to evaluate if a received second report comprises the second session correlation identifier, wherein a second interception related information is comprised in the second report; wherein
the correlating means is adapted to correlate the second interception related information with the first interception related information and the first call content if the second report comprises the second session correlation identifier.

63. The apparatus according to claim 62, wherein the first report is received from a first report delivery function, and the second report is received from a second report delivery function different from the first report delivery function.

64. The apparatus according to claim 61, wherein
the extracting means is adapted to extract a second media correlation identifier different from the first media correlation identifier from the correlation message; and the apparatus comprises
second media evaluating means adapted to evaluate if a received second message comprises the second media correlation identifier, wherein a second call content is comprised in the second message; wherein
the correlating means is adapted to correlate the second call content with the first interception related information and the first call content if the second message comprises the second media correlation identifier.

65. The apparatus according to claim 64, wherein the first message is received from a first media node, and the second message is received from a second media node different from the first media node.

66. Method, comprising
checking if a value of a main correlation identifier comprised in a first correlation message received from a first node and a value of the main correlation identifier comprised in a second correlation message received from a second node different from the first node are the same, wherein
the first correlation message additionally comprises a first secondary correlation identifier, and
the second correlation message additionally comprises a second secondary correlation identifier; and the method further comprises
generating, if the value of the main correlation identifier comprised in the first correlation message and the value of the main correlation identifier comprised in the second correlation message are the same, a main correlation message comprising the first secondary correlation identifier.

67. Method, comprising
extracting a first session correlation identifier and a first media correlation identifier from a received correlation message;
evaluating if a received first report comprises the first session correlation identifier, wherein a first interception related information is comprised in the first report;
evaluating if a received first message comprises the first media correlation identifier, wherein a first call content is comprised in the first message;
correlating the first interception related information and the first call content if the first report comprises the first session correlation identifier and the first message comprises the first media correlation identifier.

68. A computer program product embodied on a non-transitory computer-readable medium, said product comprising a set of instructions stored on the non-transitory medium which, when executed on an apparatus, is configured to cause the apparatus to carry out the method according to claim 66.
